(19) United States
(12) Patent Application Publication
(10) Pub. No.: US 2025/0392884 A1
(43) Pub. Date: Dec. 25, 2025

(54) Systems and Methods for Automated Identification of Misplaced Tags

(71) Applicant: Zebra Technologies Corporation, Lincolnshire, IL (US)

(72) Inventors: Timothy B. Austin, Stony Brook, NY (US); Elias V. Vargas, Caldwell, NJ (US)

(21) Appl. No.: 18/937,749

(22) Filed: Nov. 5, 2024

Related U.S. Application Data
(60) Provisional application No. 63/662,335, filed on Jun. 20, 2024.

(51) Int. Cl. H04W 4/029; G06F 16/55; G06F 16/587; G06T 7/70

(52) U.S. Cl. CPC H04W 4/029; G06F 16/55; G06F 16/587; G06T 7/70

(57) ABSTRACT

Systems and methods for automated identification of misplaced tags are disclosed herein. An example method includes receiving one or more signals from one or more tags. The example method further includes generating, based on the one or more signals, a location estimate for the one or more tag, and identifying, based on the location estimates, a respective cluster that satisfies a cluster threshold. The example method further includes determining whether a tag associated with the respective cluster (i) satisfies a first location threshold relative to an asset associated with the tag and (ii) satisfies a second location threshold relative to another cluster location; determining, based on (i) and (ii), an alert instruction corresponding to the tag; and transmitting the alert instruction to a user device.

### BACKGROUND

In retail environments, inventory management and item placement optimization are ongoing challenges. Misplaced items, whether due to customer actions, employee errors, or theft, can significantly impact store operations. This includes not only the direct loss of inventory, but also indirect losses through reduced sales velocity. Moreover, the phenomenon where customers are hesitant to purchase the last item from a shelf, fearing something might be wrong with it, further complicates inventory management. These challenges necessitate sophisticated tracking and management solutions to ensure that items are correctly placed and that inventory levels are accurately maintained.

However, simply identifying misplaced items or single/lone items at a display location may be insufficient to address the complexities of item placement and inventory optimization. For example, items misplaced by customers may require a different solution from items improperly stocked by associates. Accordingly, the ability to discern the context of an item's location is important when determining how to address any issues with the item's location, and this discernment is difficult for conventional techniques to accomplish, among other challenges.

Accordingly, a need exists for techniques to improve inventory management and optimize item placement.

### SUMMARY

In some aspects, the techniques described herein relate to a system including: one or more processors; and one or more memories communicatively coupled to the one or more processors, the one or more memories storing instructions thereon that, when executed by the one or more processors, cause the system to: receive one or more signals from one or more tags, each tag of the one or more tags being clustered into one or more clusters, and each tag of the one or more tags being associated with an asset of one or more assets, generate, based on the one or more signals, a location estimate for the one or more tags, identify, based on the location estimates, a respective cluster of the one or more clusters that satisfies a cluster threshold, determine whether a tag associated with the respective cluster (i) satisfies a first location threshold relative to the asset associated with the tag and (ii) satisfies a second location threshold relative to another cluster location, determine, based on (i) and (ii), an alert instruction corresponding to the tag, and transmit the alert instruction to a user device.

In some aspects, the techniques described herein relate to a system, wherein the instructions, when executed by the one or more processors, further cause the system to: group, based on an associated asset of the one or more assets, each tag of the one or more tags into one or more groups; and wherein each signal of the one or more signals at least one of: (i) indicates a group of the one or more groups associated with the respective asset or (ii) causes the system to retrieve an indication of the group associated with the respective asset.

In some aspects, the techniques described herein relate to a system, wherein each asset of the one or more assets includes an asset identifier that indicates (i) an asset type and (ii) an asset attribute, and the instructions, when executed by the one or more processors, further cause the system to group each tag of the one or more tags into the one or more groups by: determining, for each asset of the one or more assets based on the asset type and the asset attribute, a similarity value between each pair of assets from the one or more assets; and grouping, based on the similarity values, each tag of the one or more tags into the one or more groups.

In some aspects, the techniques described herein relate to a system, wherein the instructions, when executed by the one or more processors, further cause the system to: cluster, by a distance limit clustering algorithm based on the location estimates of tags within respective groups of the one or more groups, the tags within the respective groups into the one or more clusters; and wherein the distance limit clustering algorithm compares respective distances of each tag in a respective group to one or more other tags in the respective group to a distance threshold when clustering within each group.

In some aspects, the techniques described herein relate to a system, wherein the distance limit clustering algorithm includes at least one of: (i) an Agglomerative Hierarchical Clustering algorithm or (ii) a Density-Based Spatial Clustering of Applications with Noise (DBSCAN) algorithm.

In some aspects, the techniques described herein relate to a system, wherein the instructions, when executed by the one or more processors, further cause the system to identify that the respective cluster satisfies the cluster threshold by: determining that the tag is the only tag included in the respective cluster; and determining that a respective group corresponding to the respective cluster also corresponds to another cluster of the one or more clusters.

In some aspects, the techniques described herein relate to a system, wherein the cluster location is a first cluster location, and the instructions, when executed by the one or more processors, further cause the system to determine the alert instruction by: determining that the tag (i) satisfies the first location threshold and (ii) satisfies the second location threshold; and wherein the alert instruction includes an indication to either: (i) relocate the asset associated with the tag from the first cluster location to a second cluster location associated with another cluster of the one or more clusters, the another cluster including respective assets of the one or more assets included in a same group of the one or more groups as the asset associated with the tag, or (ii) relocate the respective assets from the second cluster location to the first cluster location.

In some aspects, the techniques described herein relate to a system, wherein the instructions, when executed by the one or more processors, further cause the system to determine the alert instruction by: determining that the tag (i) satisfies the first location threshold and (ii) fails to satisfy the second location threshold; and wherein the alert instruction includes an indication to relocate the asset associated with the tag to the cluster location.

In some aspects, the techniques described herein relate to a system, wherein the instructions, when executed by the one or more processors, further cause the system to determine the alert instruction by: determining that the tag (i) fails to satisfy the first location threshold and (ii) fails to satisfy the second location threshold; and wherein the alert instruction includes an indication of (i) a time when a respective signal from the tag indicated a different location of the tag from a prior signal from the tag and (ii) a path of the tag from a current location of the tag to the cluster location.

In some aspects, the techniques described herein relate to a system, wherein the instructions, when executed by the one or more processors, further cause the system to determine the alert instruction by: determining that the tag (i) fails to satisfy the first location threshold and (ii) satisfies the second location threshold; generating the alert instruction to include a removal indication corresponding to the tag; and wherein transmitting the alert instruction to the user device causes the user device to remove the tag from a tag database in accordance with the removal indication.

In some aspects, the techniques described herein relate to a system, wherein the tag is a first tag, and the instructions, when executed by the one or more processors, further cause the system to: generate a misplaced tag list that includes the first tag and a second tag of the one or more tags; determine a respective location of the second tag based on the respective signal corresponding to the second tag; determine whether (i) a prior signal corresponding to the second tag satisfies a time threshold and (ii) the respective location of the second tag satisfies a historical location threshold; and responsive to determining, for the second tag, that the prior signal fails to satisfy the time threshold and the respective location fails to satisfy the historical location threshold, remove the second tag from the misplaced tag list.

In some aspects, the techniques described herein relate to a system, wherein the instructions, when executed by the one or more processors, further cause the system to: capture image data of a respective location corresponding to the respective cluster; and analyze the captured image data to determine whether the tag (i) satisfies the first location threshold and (ii) satisfies the second location threshold.

In some aspects, the techniques described herein relate to a system, wherein the one or more tags are radio-frequency identification (RFID) tags, and the system further includes one or more RFID readers configured to: receive the one or more signals from the one or more RFID tags; and generate, based on the one or more signals, the location estimates for the one or more tags, wherein the location estimates include three-dimensional (3D) locations for the one or more RFID tags.

In some aspects, the techniques described herein relate to a system, wherein the instructions, when executed by the one or more processors, further cause the system to determine whether the tag (i) satisfies the first location threshold and (ii) satisfies the second location threshold by: generating a direction instruction indicating directions to the location estimate of the tag based on a current location of at least one of: (i) a user, (ii) a device of the user, or (iii) an autonomous mobile device connected to the system; and transmitting the direction instruction to the user device, wherein the user device includes at least one of: (i) the device of the user or (ii) the autonomous mobile device; or generating, based on the location estimate of the tag, a control instruction configured to orient an imaging system to capture image data of the tag; and transmitting the control instruction to the imaging system to (i) orient the imaging system in accordance with the control instruction and (ii) capture the image data of the tag.

In some aspects, the techniques described herein relate to a system, wherein the instructions, when executed by the one or more processors, further cause the system to: receive location confirmation data corresponding to the current location of the tag from at least one of: (i) the user, (ii) the device of the user, (iii) the autonomous mobile device, or (iv) the imaging system; and determine whether the tag (i) satisfies the first location threshold and (ii) satisfies the second location based on the location confirmation data.

In some aspects, the techniques described herein relate to a method including: receiving one or more signals from one or more tags, each tag of the one or more tags being clustered into one or more clusters, and each tag of the one or more tags being associated with an asset of one or more assets; generating, based on the one or more signals, a location estimate for the one or more tags; identifying, based on the location estimates, a respective cluster of the one or more clusters that satisfies a cluster threshold; determining whether a tag associated with the respective cluster (i) satisfies a first location threshold relative to the asset associated with the tag and (ii) satisfies a second location threshold relative to another cluster location; determining, based on (i) and (ii), an alert instruction corresponding to the tag; and transmitting the alert instruction to a user device.

In some aspects, the techniques described herein relate to a method, further including: grouping, based on an associated asset of the one or more assets, each tag of the one or more tags into one or more groups; and wherein each signal of the one or more signals at least one of: (i) indicates a group of the one or more groups associated with the respective asset or (ii) causes retrieval of an indication of the group associated with the respective asset.

In some aspects, the techniques described herein relate to a method, wherein each asset of the one or more assets includes an asset identifier that indicates (i) an asset type and (ii) an asset attribute, and grouping each tag of the one or more tags into the one or more groups further includes: determining, for each asset of the one or more assets based on the asset type and the asset attribute, a similarity value between each pair of assets from the one or more assets; and grouping, based on the similarity values, each tag of the one or more tags into the one or more groups.

In some aspects, the techniques described herein relate to a method, further including: clustering, by a distance limit clustering algorithm based on the location estimates of tags within respective groups of the one or more groups, the tags within the respective groups into the one or more clusters; and wherein the distance limit clustering algorithm compares respective distances of each tag in a respective group to one or more other tags in the respective group to a distance threshold when clustering within each group.

In some aspects, the techniques described herein relate to a tangible machine-readable medium including instructions that, when executed, cause a machine to at least: receive one or more signals from one or more tags, each tag of the one or more tags being clustered into one or more clusters, and each tag of the one or more tags being associated with an asset of one or more assets; generate, based on the one or more signals, a location estimate for the one or more tags; identify, based on the location estimates, a respective cluster of the one or more clusters that satisfies a cluster threshold; determine whether a tag associated with the respective cluster (i) satisfies a first location threshold relative to the asset associated with the tag and (ii) satisfies a second location threshold relative to another cluster location; determine, based on (i) and (ii), an alert instruction corresponding to the tag; and transmit the alert instruction to a user device.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 depicts an example environment in which systems/methods for automated identification of misplaced tags may be implemented, in accordance with embodiments described herein.

FIG. 2A depicts a first example scenario in which a representative tag and associated asset are located within a cluster of similarly grouped items/tags that has a low cluster size, in accordance with various embodiments described herein.

FIG. 2B depicts a second example scenario in which a representative tag located within a cluster of similarly grouped tags/items is not co-located with the associated asset, in accordance with various embodiments described herein.

FIG. 2C depicts a third example scenario in which a representative tag and associated asset are not located within a cluster of similarly grouped tags/assets, in accordance with various embodiments described herein.

FIG. 2D depicts a fourth example scenario in which a representative tag is neither co-located with the associated asset nor within a cluster of similarly grouped tags/assets, in accordance with various embodiments described herein.

FIG. 3 is a block diagram of an example environment for implementing example methods and/or operations described herein.

FIG. 4 is a flowchart representative of a method for automated identification of misplaced tags, in accordance with embodiments described herein.

FIG. 5 is another flowchart representative of a method for automated identification of misplaced tags, in accordance with embodiments described herein.

FIG. 6 is yet another flowchart representative of a method for automated identification of misplaced tags, in accordance with embodiments described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As mentioned, a need exists for sophisticated solutions to the challenges faced by retail environments in managing inventory, ensuring product availability, and minimizing losses due to theft or misplacement. Items may not be at their expected locations (e.g., display locations) for various reasons such as customer interactions, stocking errors, or theft. Additionally, certain customers may be hesitant to purchase the last item from a shelf, often referred to as the “last slice of cake in the breakroom” issue, which further exacerbates the challenge of optimizing inventory management.

To address these challenges, among others, the systems and methods of the present disclosure focus on the use of Radio-Frequency Identification (RFID) technology and advanced clustering algorithms to automatically identify and locate RFID tags associated with (e.g., affixed or not affixed) items (also referenced herein as “assets”) that are not positioned with similar items. The techniques described herein also generate prescriptive actions (e.g., alert instructions) based on the location of the RFID tag, and may further analyze/utilize image data of the tag's location to inform such alert instructions. These techniques thereby leverage the capabilities of RFID technology to provide precise location tracking of items within a retail environment, offering a solution that is both innovative and practical.

The present techniques significantly improve the processing capabilities within a retail environment by automating the identification and location of misplaced items. In particular, the present techniques generate a location estimate of a tag based on the signal(s) received from the tag and evaluate whether the tag satisfies one or more thresholds based on the location estimate and a cluster containing the tag. In this manner, the techniques of the present disclosure provide highly granular determinations of the tag location, such as whether the tag (and corresponding asset) is the last tag located at a display location or whether the tag is located at a non-display location, which was previously unachievable using conventional techniques.

The present techniques also optimize network and processing resource usage by intelligently managing the data flow between RFID readers, the central server, and autonomous mobile robots (AMRs), user devices, and/or static cameras configured to capture image data of tags. Namely, by filtering out tags that have not been read in a specified timeframe or have moved significantly since the last read, the present techniques ensure that only relevant data is transmitted and processed. This selective data transmission and analysis minimizes network congestion, reduces the overall demand on processing resources, and enhances the responsiveness of the system to real-time changes in the retail environment.

Further, the present techniques improve memory usage through efficient data management and storage practices. By grouping similar assets and utilizing clustering algorithms (e.g., density-based clustering algorithms) to further organize tags/assets within groups, the present techniques organize data in a manner that facilitates quick access and analysis. This structured approach to data management allows for the compact storage of information regarding item locations and movements, thereby optimizing memory resources and ensuring the system's scalability.

Thus, in accordance with the above, and with the disclosure herein, the present disclosure includes improvements in computer functionality or improvements to other technologies at least because the present disclosure describes that, e.g., RFID systems, and their related various components, may be improved or enhanced with the disclosed automatic identification of misplaced tags that provides more accurate locationing/tracking services for RFID tags and corresponding assets. That is, the present disclosure describes improvements in the functioning of an RFID system itself or “any other technology or technical field” (e.g., the field of distributed/industrial locationing systems) because the disclosed automatic identification of misplaced tags improves and enhances operation of locationing systems by introducing tag/asset grouping, clustering, and location thresholding that enhance tag/asset misplacement and/or non-optimal placement situational granularity and reduce/eliminate other inefficiencies typically experienced over time by locationing systems lacking such automatic identification of misplaced tags. This improves the state of the art at least because such previous RFID systems are inaccurate as they lack the ability for automatic identification of misplaced tags in the manners described herein.

In addition, the present disclosure includes applying various features and functionality, as described herein, with, or by use of, a particular machine, e.g., a tag, a reader, a server, and/or other hardware components as described herein.

Moreover, the present disclosure includes specific features other than what is well-understood, routine, conventional activity in the field, or adding unconventional steps that demonstrate, in various embodiments, particular useful applications, e.g., generating, based on the one or more signals, a location estimate for the one or more tags; identifying, based on the location estimates, a respective cluster of the one or more clusters that satisfies a cluster threshold; determining whether a tag associated with the respective cluster (i) satisfies a first location threshold relative to the asset associated with the tag and (ii) satisfies a second location threshold relative to another cluster location; determining, based on (i) and (ii), an alert instruction corresponding to the tag; and/or transmitting the alert instruction to a user device, among others.

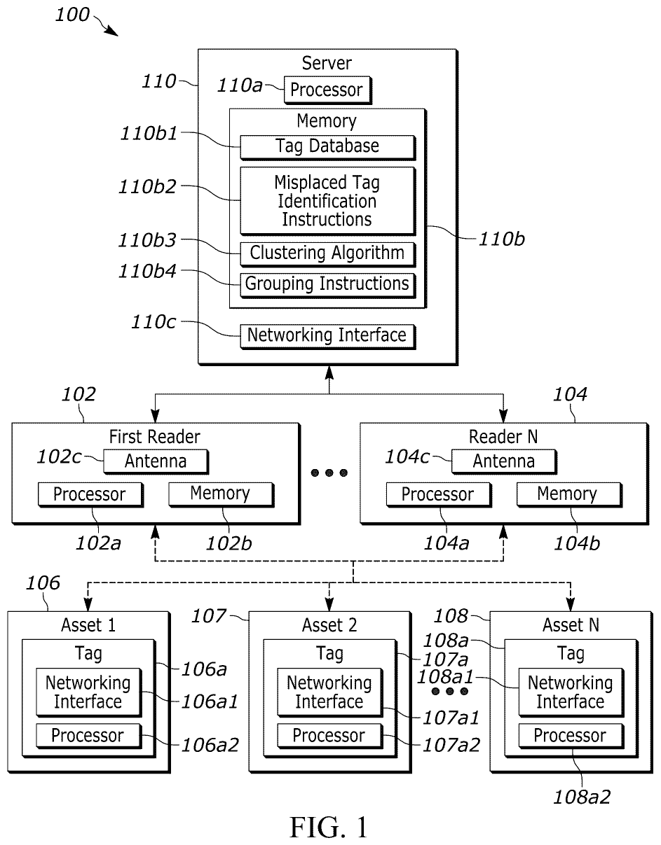

Turning to the figures, FIG. 1 depicts an example environment 100 in which systems/methods for automated identification of misplaced tags may be implemented, in accordance with embodiments described herein. The example environment 100 may comprise, include, and/or otherwise be a part of a networking environment in which the systems/devices of the present disclosure may operate. In the example embodiment of FIG. 1, the example environment 100 includes a first reader 102 and an Nth reader 104 that may be communicatively coupled to a first tag 106a of a first asset 106, a second tag 107a of a second asset 107, a third tag 108a of an Nth asset 108, and a server 110. Generally, the first reader 102, the Nth reader 104, the first tag 106a, the second tag 107a, the third tag 108a, and/or the server 110 may be capable of executing instructions to, for example, implement operations of the example methods described herein, as may be represented by the flowcharts of the drawings that accompany this description. Namely, the first reader 102 and/or the Nth reader 104 may be connected to the first tag 106a, the second tag 107a, the third tag 108a, and/or the server 110 across multiple communication channels and may generally be configured to receive and process information received from the first tag 106a, the second tag 107a, the third tag 108a, and/or the server 110. One or more of the tags 106a, 107a, 108a may be, for example, an RFID tag including an antenna (e.g., coupled to and/or otherwise comprising part of the respective networking interface 106a1, 107a1, 108a1) connected to an integrated circuit.

As referenced herein, a tag may be associated with and/or otherwise correspond to an asset when a tag identifier of the tag is stored (e.g., in the tag database 110b1) in association with an Electronic Product Code (EPC), a serial number, a stock keeping unit (SKU) number, and/or another unique identifier of the asset and/or the data packets transmitted by the tag including an indication of the corresponding asset's unique identifier. In this manner, when a reader (e.g., 102, 104) receives a signal from the tag, a server (e.g., 110) may determine the corresponding asset for the tag by accessing the relevant storage location (e.g., in the tag database 110b1) associated with the tag and retrieving the corresponding asset's unique identifier and/or any other stored properties (e.g., asset group, cluster, asset type, asset attribute(s)) of the corresponding asset. Moreover, the tag being associated with and/or corresponding to the asset may generally indicate that the tag is affixed to, coupled with, and/or otherwise physically associated with the corresponding asset, such that the estimated location of the tag (e.g., as determined by the readers 102, 104 or the server 110) may generally correspond to the location of the corresponding asset.

The example environment 100 may be or include any suitable real-world environment, such as a grocery store, loading warehouse, hospital, etc., and the area(s) of interest covered by the first reader 102 and/or the Nth reader 104 may be or include high travel density asset pathways corresponding to the real-world environment. For example, an area of interest covered by the signal beams of the first reader 102 and/or the Nth reader 104 may include an entry/exit pathway to/from a grocery store, where the first reader 102 and/or the Nth reader 104 may track dynamic assets as entities enter/exit the store. Additionally, or alternatively, the first reader 102 and/or the Nth reader 104 may be located near one or more clusters of assets located within a retail environment and may generally receive signals transmitted by the corresponding tags (e.g., tag 106a, 107a, 108a) of the assets included in the one or more clusters. As another example, an area of interest may be individual loading docks, storage areas, movement pathways for equipment/machinery, etc. within a warehouse.

The assets 106, 107, 108 may generally be any device, component, or object that an entity may desire to track and/or otherwise locate. For example, the assets 106, 107, 108 may be large and calibrated tools used in and/or for oil and gas equipment/operations, parcels for delivery by a shipping company, hospital equipment that is and/or may be moved to different floors/rooms, wristbands attached to hospital patients, and/or any other suitable objects or combinations thereof. While illustrated as three assets 106, 107, 108, it should be appreciated that the first reader 102 and/or the Nth reader 104 may simultaneously communicate with any suitable number of assets 106, 107, 108 via the associated tags 106a, 107a, 108a. Thus, the Nth asset 108 may be a third asset, a fifth asset, a twentieth asset, a one-hundredth asset, and/or any other integer value asset. Moreover, it should be appreciated that any suitable number of readers may be configured to communicate with the assets 106, 107, 108 as part of a single locationing system. Thus, the Nth reader 104 may be a second reader, a fifth reader, a twentieth reader, a one-hundredth reader, and/or any other integer value reader.

Each asset 106, 107, 108 may also include a corresponding tag 106a, 107a, 108a that may be configured to respond to polling requests by transmitting information associated with the asset via the networking interfaces 106a1, 107a1, 108a1 to, for example, the first reader 102 and/or the Nth reader 104. Each asset tag 106a, 107a, 108a may also include one or more processors 106a2, 107a2, 108a2 configured to interpret and/or execute such polling requests and/or other instructions contained in signals received from the first reader 102, the Nth reader 104, the server 110, and/or other suitable device(s). For example, the processors 106a2, 107a2, 108a2 may be configured to interpret polling requests and/or other signals received from the first reader 102 and/or the Nth reader 104 and thereby transmit data packets to the first reader 102 and/or the Nth reader 104.

The first reader 102 has one or more processors 102a, one or more memories 102b, and an antenna 102c. The Nth reader 104 has one or more processors 104a, one or more memories 104b, and an antenna 104c. The first reader 102 and the Nth reader 104 are generally configured to transmit and receive data to/from the server 110 and nearby tags (e.g., the first tag 106a, the second tag 107a, the third tag 108a). In certain embodiments, the first reader 102 and/or the Nth reader 104 may be an ultra-high frequency (UHF) RFID reader device that communicates with some/all of the devices in the environment 100 via UHF radio signals. In some embodiments, the first reader 102 and/or the Nth reader 104 may be a device that executes and/or conforms to any suitable software operating system (e.g., Android, iOS), a custom Internet of Things (IoT) bridge device with a UHF radio, and/or any other suitable device or combination thereof.

Namely, the first reader 102 and/or the Nth reader 104 are generally configured to periodically listen for data packets from nearby tags (e.g., tags 106a, 107a, 108a), transmit the data packets and/or data obtained therein to the server 110, and/or broadcast requests received from the server 110 to such nearby tags via the antennas 102c, 104c. As an example, the first reader 102 and/or the Nth reader 104 may receive requests from the server 110, and may subsequently transmit requests to proximate tags 106a, 107a, 108a based on the requests. Such requests from the server 110 may be or include instructions causing the tags 106a, 107a, 108a to transmit identification data to the first reader 102 and/or the Nth reader 104 and/or other suitable instructions or combinations thereof.

The antennas 102c, 104c may be generally configured to transmit/receive data streams to/from various devices of the example environment 100, such as the server 110 and/or the tags 106a, 107a, 108a. The antennas 102c, 104c may each have an associated gain profile corresponding to converting input power into radio waves (e.g., transmission) and/or received radio waves into electrical power (e.g., receiving). For example, the antennas 102c, 104c may be phased-array antennas configured to transmit and receive signal beams in various directions. Each of the antennas 102c, 104c may have a corresponding “coverage area”, which may refer to the complete geometrical area where an antenna is able to transmit/receive signals to/from an RFID tag. This coverage area may generally correspond to a physical region within an environment (e.g., a retail environment), such that signals received by the antennas 102c, 104c from tags 106a, 107a, 108a located within the antenna 102c, 104c coverage areas can be mapped to locations within the environment.

The server 110 includes one or more processors 110a, one or more memories 110b storing a tag database 110b1, misplaced tag identification instructions 110b2, a clustering algorithm 110b3, and grouping instructions 110b4, and a networking interface 110c. The misplaced tag identification instructions 110b2 generally include instructions configured to analyze and interpret received tag signals, determine whether a tag and/or a corresponding cluster satisfies one or more threshold criteria (e.g., location thresholds, cluster thresholds), and generate and transmit alert instructions to one or more individuals, robots, imaging/camera systems, and/or other components configured to capture image data of the tag/asset, relocate the tag/asset, and/or otherwise interact with the tag/asset.

As mentioned, each received tag signal (e.g., from tags 106a, 107a, 108a) may include identifying information of the tag and/or a corresponding asset to which the tag is affixed and/or otherwise associated included as part of the data packets comprising the tag signals. This unique identifier, such as an EPC or a similar code, is stored within the tag's memory and may be transmitted to the reader (e.g., 102, 104) when the tag comes within the reader's coverage area. The readers 102, 104 and/or the server 110 can thereby identify the tag/asset through the unique identification number or other code embedded in the tag that is incorporated in the transmitted tag signal(s) by accessing the tag database 110b1, such that the readers 102, 104 and/or the server 110 can distinguish between different tags and, by extension, the assets to which those tags are affixed or otherwise associated. Accordingly, while illustrated in FIG. 1 as being contained only within the server 110, the readers 102, 104 may also store portions of the misplaced tag identification instructions 110b2 to, for example, interpret the tag signals and access the tag database 110b1 to retrieve information corresponding to the tags/assets.

The misplaced tag identification instructions 110b2 may further cause the server 110 and/or readers 102, 104 to determine location estimates of the tag. For example, if the tags 106a, 107a, 108a and readers 102, 104 form part of a passive RFID system, the readers 102, 104 and/or the server 110 may inferentially determine the tag 106a, 107a, 108a locations based on coverage areas of the reader(s) 102, 104 that receive signals from the tag. In certain instances, the readers 102, 104 and/or the server 110 may utilize triangulation based on, for example, the signal strength from multiple antennas and/or readers 102, 104 to estimate the tag's location. As another example, if the tags 106a, 107a, 108a and readers 102, 104 form part of an active RFID system (e.g., tags 106a, 107a, 108a have their own power sources and can transmit signals independent of proximity to a reader), the readers 102, 104 and/or the server 110 may determine the tag 106a, 107a, 108a locations based on, e.g., signal strength, time of flight, phase difference of the tag's signal as received by multiple readers 102, 104 and/or any other suitable method(s) or combinations thereof to calculate the tag's location.

More generally, the location of a tag may be represented in terms of the environment in which the tag is located (e.g., aisle 4, shelf 3 of a grocery store) and/or may be represented in terms of a three-dimensional (3D) coordinate system (e.g., Cartesian coordinates) where the origin of the coordinate system is either pre-defined or established by the server 110 as part of the misplaced tag identification instructions 110b2. Additionally, or alternatively, the readers 102, 104 and/or the server 110 may leverage other locationing technologies, such as Wi-Fi or Bluetooth®, to further inform the tag location determinations.

The misplaced tag identification instructions 110b2 further include determining which cluster of one or more clusters in which each tag is included. At a high level, each asset (to which the tags are associated) is grouped into one or more groups based on, e.g., asset types (e.g., apparel, coolers, pillows, etc.) and asset attributes (e.g., colors, brands, size, etc.), and each group may be sub-divided into one or more clusters based on the physical layout of the environment (e.g., a retail environment). Thus, each cluster may generally represent a set/collection of assets/tags that are from the same group and are collocated (e.g., nearby one another) within the environment, and each group of assets may have one or more clusters within the environment (e.g., multiple, distinct display locations for pillows within a retail environment). Of course, as assets from these clusters are purchased and/or otherwise moved, the size of each cluster may change over time, and individual assets/tags may be moved to other locations within the environment that, e.g., do not correspond to the original cluster of the asset/tag or any other cluster of assets/tags from the same group. Tracking the movement of each asset/tag with respect to their original and/or associated clusters thus enables the systems described herein (e.g., readers 102, 104 and server 110) to accurately determine a suitable corrective action to be taken depending on, for example, (i) whether the tag is collocated (e.g., affixed to and/or otherwise proximate to) with the asset and (ii) whether the tag (and potentially the asset) are collocated with other assets from the same group (e.g., is not in a cluster or is the last/only tag in the cluster).

The misplaced tag identification instructions 110b2 thus include generating, based on one or more signals received from the tags (e.g., 106a, 107a, 108a), a location estimate for the tags, identifying, based on the location estimates, a respective cluster of the one or more clusters that satisfies a cluster threshold, and determining whether a tag associated with the respective cluster (i) satisfies a first location threshold relative to the asset associated with the tag and (ii) satisfies a second location threshold relative to another cluster location. The cluster threshold generally corresponds to whether a tag is the only tag included in a respective cluster and whether a respective group corresponding to the respective cluster also corresponds to another cluster of the one or more clusters. The respective cluster including the tag can thereby satisfy the cluster threshold when the tag is the only tag included in the cluster and the group associated with the respective cluster also has another cluster located within the environment (e.g., multiple, distinct display locations for pillows within a retail environment). If the tag is one of multiple tags included in the respective cluster or the respective cluster is the only cluster within the environment that is associated with the respective group, then the tag can be said to not satisfy the cluster threshold.

In certain embodiments, the tag may satisfy the cluster threshold when the tag is one of a number of tags within the cluster, but the total number of tags in the cluster is less than a threshold amount (e.g., number of tags in cluster<5), and/or even if the cluster is the only cluster associated with the respective group in the environment. For example, the cluster may only include four tags/assets, and the cluster may have remained at four tags/assets for a certain period of time (e.g., multiple days) while assets from another cluster in the same group have been steadily removed from the environment (e.g., sold) over the same period of time. The misplaced tag identification instructions 110b2 may thus generate an alert instruction indicating that the four assets should be moved to the display location associated with the other cluster. As another example, a cluster of assets from a particular group may have a static number of tags/assets over a period of time (e.g., multiple weeks), such that moving this cluster to a different location within the environment may result in more tag/asset movement (e.g., sales). The misplaced tag identification instructions 110b2 may thus generate an alert instruction indicating that the cluster should be relocated to a different location within the environment.

The location thresholds generally indicate whether the tag is collocated with and/or otherwise proximate to the corresponding asset and/or a cluster of tags/assets that are part of the same group as the corresponding asset. The first location threshold may be, e.g., a binary determination (e.g., tag affixed/not affixed to an asset) and/or a threshold distance (e.g., one foot, two feet, five feet, etc.) of the tag relative to the corresponding asset. For example, if the tag is not located within a cluster of similarly grouped assets, an individual (e.g., retail personnel), an autonomous robot, and/or a camera system may capture image data of the tag and/or otherwise view the tag's location to determine whether the tag is still affixed and/or otherwise collocated with the asset. If the tag is affixed and/or otherwise collocated (e.g., within one, two, five feet) with the corresponding asset, the tag may satisfy the first location threshold.

The second location threshold may be, e.g., a threshold distance (e.g., one foot, two feet, five feet, etc.) of the tag relative to the corresponding cluster and/or another cluster that includes assets belonging to the same group as the asset associated with the tag. Thus, depending on the implementation, a tag (and its corresponding asset) may “satisfy” the second location threshold based on the distance/location of the tag relative to the cluster in which it is included or another cluster that includes similarly grouped assets. For example, if the tag is located within two feet of a cluster location of a cluster of similarly grouped assets, the tag may satisfy the second location threshold.

Moreover, each cluster of assets may be defined in any suitable manner to have any suitable dimensions, such that the second location threshold may be different for each cluster and/or clusters of different groups. For example, a first cluster may include apparel items hung on a rack and the cluster dimensions may generally be rectangular to correspond to the dimensions of the rack/apparel items within the environment and the cluster location may include all/some locations within the boundaries of the rectangle. A second cluster may include soda cans stacked in a pyramid-style display, such that the cluster dimensions are circular/oval shaped and the cluster location may include all/some locations within the boundaries of the circle/oval. In another example, the locations of a retail environment may be coded to correspond to the particular environment terminology (e.g., rows, aisles, shelves, etc.), such that a cluster may include all locations extending from aisle 2, shelf 3, south end of aisle to aisle 2, shelf 4, north end of aisle.

The misplaced tag identification instructions 110b2 may further cause the readers 102, 104 and/or the server 110 to determine, based on whether the location thresholds are satisfied, one or more alert instructions corresponding to the tag and transmit the alert instruction to a user device (not shown). The alert instructions may generally indicate how to proceed with relocating the tag/asset, initiating procedures to recover or identify lost/stolen assets, relocating other tags/assets, removing the tag from the tag database 110b1, and/or other actions or combinations thereof. For example, the server 110 may determine that a tag (i) satisfies the first location threshold and (ii) satisfies the second location threshold. The instructions 110b2 may cause the server 110 to generate an alert instruction that comprises an indication to either: (i) relocate the asset associated with the tag from the first cluster location to a second cluster location associated with another cluster of the one or more clusters, the another cluster comprising respective assets of the one or more assets included in a same group of the one or more groups as the asset associated with the tag, or (ii) relocate the respective assets from the second cluster location to the first cluster location.

In another example, the server 110 may determine that the tag (i) satisfies the first location threshold and (ii) fails to satisfy the second location threshold. The instructions 110b2 may cause the server 110 to generate an alert instruction that comprises an indication to relocate the asset associated with the tag to the cluster location.

In yet another example, the server 110 may determine that the tag (i) fails to satisfy the first location threshold and (ii) fails to satisfy the second location threshold. The instructions 110b2 may cause the server 110 to generate an alert instruction that comprises an indication of (i) a time when a respective signal from the tag indicated a different location of the tag from a prior signal from the tag and (ii) a path of the tag from a current location of the tag to the cluster location.

In still another example, the server 110 may determine that the tag (i) fails to satisfy the first location threshold and (ii) satisfies the second location threshold. The instructions 110b2 may cause the server 110 to generate an alert instruction that comprises a removal indication corresponding to the tag. Accordingly, the server 110 may remove the tag from the tag database 110b1 and may transmit the alert instruction to the user device causing the user device to remove the tag from the tag database 110b1 and/or otherwise informing the user device that the tag has been removed from the tag database 110b1, in accordance with the removal indication.

In certain embodiments, the misplaced tag identification instructions 110b2 cause the server 110 to generate a misplaced tag list that includes a first tag and a second tag. The misplaced tag identification instructions 110b2 may further cause the server 110 to determine a respective location of the second tag based on the respective signal corresponding to the second tag and determine whether (i) a prior signal corresponding to the second tag satisfies a time threshold and (ii) the respective location of the second tag satisfies a historical location threshold. Responsive to determining, for the second tag, that the prior signal fails to satisfy the time threshold and the respective location fails to satisfy the historical location threshold, remove the second tag from the misplaced tag list.

The historical location threshold may be a distance threshold indicating whether the asset moved from the prior location in the intervening time between receipt of the prior signal and the respective (e.g., current) signal by a certain amount (e.g., two feet, five feet, ten feet, etc.). For example, the historical location threshold may be five feet, such that any tag not having been moved more than five feet within the past 24 hours may be removed from the misplaced tag list. The time threshold may generally represent an amount of time since the tag was previously read by at least one reader (e.g., 102, 104). For example, the time threshold may be 24 hours, such that any tag not having been read within the prior 24 hours may be removed from the misplaced tag list. As another example, the misplaced tag identification instructions 110b2 cause the server 110 to only include tags in the misplaced tag list when (i) the tag is the only tag in a cluster, (ii) the tag was read (e.g., by readers 102, 104) within the last hour, and (iii) the tag has not moved significantly within the last day (24 hours).

In certain embodiments, the misplaced tag identification instructions 110b2 cause the server 110 to generate and transmit instructions to capture image data of a respective location corresponding to the respective cluster; and analyze the captured image data to determine whether the tag (i) satisfies the first location threshold and (ii) satisfies the second location threshold. For example, the instructions to capture the image data may include a direction instruction indicating directions to the location estimate of the tag based on a current location of at least one of: (i) a user, (ii) a device of the user, and/or (iii) an autonomous mobile device connected to the system, and the server 110 may transmit the direction instruction to the user device, wherein the user device includes at least one of: (i) the device of the user or (ii) the autonomous mobile device. Additionally, or alternatively, the instructions to capture image data may include, based on the location estimate of the tag, a control instruction configured to orient an imaging system to capture image data of the tag, and the server 110 may transmit the control instruction to the imaging system to (i) orient the imaging system in accordance with the control instruction and (ii) capture the image data of the tag.

In certain embodiments, the tags 106a, 107a, 108a are RFID tags, and the readers 102, 104 are RFID readers configured to receive signals from the RFID tags 106a, 107a, 108a; and generate, based on the received signals, location estimates for the RFID tags 106a, 107a, 108a. Each of the location estimates may generally comprise 3D locations for the RFID tags 106a, 107a, 108a.

In some embodiments, the misplaced tag identification instructions 110b2 may cause the server 110 to receive location confirmation data corresponding to the current location of the tag from at least one of: (i) the user, (ii) the device of the user, (iii) the autonomous mobile device, or (iv) the imaging system; and determine whether the tag (i) satisfies the first location threshold and (ii) satisfies the second location based on the location confirmation data.

The clustering algorithm 110b3 generally clusters tags within a particular group into one or more clusters, using a distance limit and based on the location estimates of the tags. Thus, the clustering algorithm 110b3 may be a distance limit clustering algorithm that compares respective distances of each tag in a respective group to one or more other tags in the respective group to a distance threshold when clustering within each group. For example, the clustering algorithm 110b3 may be at least one of an Agglomerative Hierarchical Clustering algorithm, a Density-Based Spatial Clustering of Applications with Noise (DBSCAN) algorithm, and/or any other suitable clustering algorithm or combinations thereof.

The grouping instructions 110b4 generally includes instructions configured to group assets (and, by extension, tags) into one or more groups. Namely, the grouping instructions 110b4 may group, based on an associated asset of the one or more assets, each tag of the one or more tags into one or more groups. More specifically, the grouping instructions 110b4 may group the tags into the groups based on asset identifiers of the corresponding assets. Each asset may include an asset identifier that indicates (i) an asset type (e.g., cereal, soda, jeans, etc.) and (ii) an asset attribute (e.g., color, brand, size, etc.). The grouping instructions 110b4 may thereby cause the server 110 to group each tag into the one or more groups by determining, for each asset based on the asset type and the asset attribute, a similarity value between each pair of assets from the one or more assets; and grouping, based on the similarity values, each tag of the one or more tags into the one or more groups. The similarity values may be based on, for example, feature vectors of the assets that are constructed using the asset identifiers and compared using any suitable similarity metric (e.g., cosine similarity, Jaccard similarity, Euclidean distance). The signals transmitted by the tags 106a, 107a, 108a may thereby indicate a group of the one or more groups associated with the respective asset or causes the readers 102, 104 and/or the server 110 to retrieve an indication of the group associated with the respective asset (e.g., from the tag database 110b1).

The tag database 110b1 may be or include a listing of tags (e.g., tag 106a, tag 107a, tag 108a) that are proximate to specific readers (e.g., first reader 102, Nth reader 104) and/or otherwise transmit data to/from the particular reader(s). More specifically, the tag database 110b1 listings may include identification information about each of the tags 106a, 107a, 108a and/or the assets 106, 107, 108 associated with the tags 106a, 107a, 108a, as well as estimated locations determined by the first reader 102 and/or the Nth reader 104. The tag database 110b1 may more generally include any suitable information related to the tags and/or the assets associated with the tags.

To update the tag database 110b1, the first reader 102 and/or the Nth reader 104 may periodically request and/or otherwise receive updates from various tags (e.g., tag 106a, tag 107a, tag 108a) disposed around an environment (e.g., example environment 100), using the antennas 102c, 104c. Based on the signals received by the antennas 102c, 104c, the first reader 102 and/or the Nth reader 104 may determine (via the one or more processors 102a, 104a) one or more tags indicated in the received data. The first reader 102 and/or the Nth reader 104 may then update the tag listing for each tag 106a, 107a, 108a by inputting the data received from the respective tags 106a, 107a, 108a into the corresponding tag listing of the tag database 110b1. For example, the tag database 110b1 may indicate at a first time that the first reader 102 received data from the first tag 106a and the second tag 107a via the antenna 102c. At a second time, the Nth reader 104 may transmit a request to and/or may otherwise receive an update from proximate tags indicating that the Nth reader 104 received/captured data from the first tag 106a and the second tag 107a via the antenna 104c. Thus, the entries of the tag database 110b1 may indicate that the first asset 106 and the second asset 107 moved out of a read zone of the first reader 102 (e.g., read zone of the antenna 102c) and into a receptive proximity of the Nth reader 104 (e.g., read zone of antenna 104c) at some point between the first time and the second time, such that the first reader 102 was unable to receive data transmitted from the first tag 106a and the second tag 107a at the second time and the Nth reader 104 was able to receive the data transmitted from the first tag 106a and the second tag 107a at the second time.

Moreover, in certain embodiments, a workstation (not shown) may be communicatively connected to the server 110, and a user/operator may access the server 110 to retrieve a location associated with an asset 106, 107, 108. The workstation may query the server 110 with the identification tag of the corresponding asset 106, 107, 108, and the server 110 may match the identification tag with a location entry in the tag database 110b1 associated with the corresponding asset 106, 107, 108. The server 110 may then forward the location entry to the workstation for viewing by the user/operator.

More generally, the one or more memories 102b, 104b, 110b may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. In general, a computer program or computer based product, application, or code (e.g., misplaced tag identification instructions 110b2, clustering algorithm 110b3, grouping instructions 110b4, and/or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the one or more processors 102a, 104a, 110a (e.g., working in connection with a respective operating system in the one or more memories 102b, 104b, 110b) to facilitate, implement, or perform the machine readable instructions, methods, processes, elements or limitations, as illustrated, depicted, or described for the various flowcharts, illustrations, diagrams, figures, and/or other disclosure herein.

In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.). Moreover, the one or more memories 102b, 104b, 110b may also store machine readable instructions, including any of one or more application(s), one or more software component(s), and/or one or more APIs, which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein.

The one or more processors 102a, 104a, 110a may be connected to the one or more memories 102b, 104b, 110b via a computer bus (not shown) responsible for transmitting electronic data, data packets, or otherwise electronic signals to and from the one or more processors 102a, 104a, 110a and one or more memories 102b, 104b, 110b to implement or perform the machine readable instructions, methods, processes, elements or limitations, as illustrated, depicted, or described for the various flowcharts, illustrations, diagrams, figures, and/or other disclosure herein.

The one or more processors 102a, 104a, 110a may interface with the one or more memories 102b, 104b, 110b via the computer bus to execute any suitable application or executable instructions (e.g., misplaced tag identification instructions 110b2, clustering algorithm 110b3, grouping instructions 110b4) necessary to perform any of the actions associated with the methods of the present disclosure. The one or more processors 102a, 104a, 110a may also interface with the one or more memories 102b, 104b, 110b via the computer bus to create, read, update, delete, or otherwise access or interact with the data stored in the one or more memories 102b, 104b, 110b and/or external databases (e.g., a relational database, such as Oracle, DB2, MySQL, or a NoSQL based database, such as MongoDB). The data stored in the one or more memories 102b, 104b, 110b and/or an external database may include all or part of any of the data or information described herein, including, for example, the tag database 110b1, asset tag 106a, 107a, 108a data packets, asset location data, clustering/grouping algorithms, misplaced tag identification instructions, alert instructions, and/or other suitable information or combinations thereof.

The networking interfaces 106a1, 107a1, 108a1, 110c and/or the antennas 102c, 104c may be configured to communicate (e.g., send and receive) data via one or more external/network port(s) to one or more networks or local terminals, as described herein. In some embodiments, the server 110, the first reader 102, and/or the Nth reader 104 may include a client-server platform technology such as ASP.NET, Java J2EE, Ruby on Rails, Node.js, a web service or online API, responsive for receiving and responding to electronic requests. The server 110, the first reader 102, and/or the Nth reader 104 may accordingly implement the client-server platform technology that may interact, via the computer bus, with the one or more memories 102b, 104b, 110b (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

According to some embodiments, the networking interfaces 106a1, 107a1, 108a1, 110c and/or the antennas 102c, 104c may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to a network. In some embodiments, the network (not shown) may comprise a private network or local area network (LAN). Additionally, or alternatively, the network may comprise a public network such as the Internet. In some embodiments, the network may comprise routers, wireless switches, or other such wireless connection points communicating with the server 110 (via networking interface 110c) via wireless communications based on any one or more of various wireless standards, including by non-limiting example, an RFID standard, a Bluetooth® standard (e.g., BLE), IEEE 802.11a/b/c/g (WIFI), or the like. In certain embodiments, the first reader 102 and/or the Nth reader 104 may also communicate with the server 110 via any suitable network and corresponding network interface (not shown).

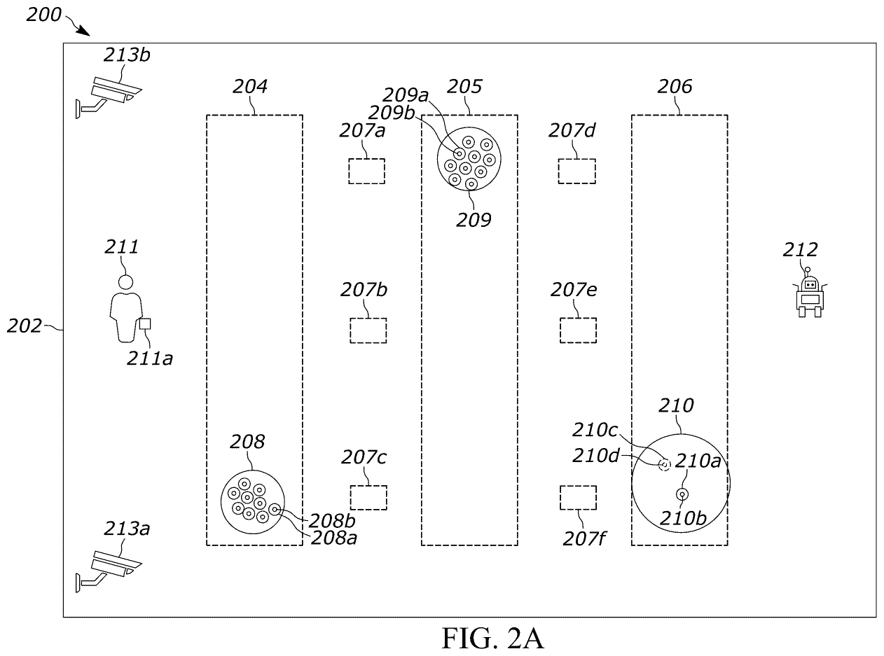

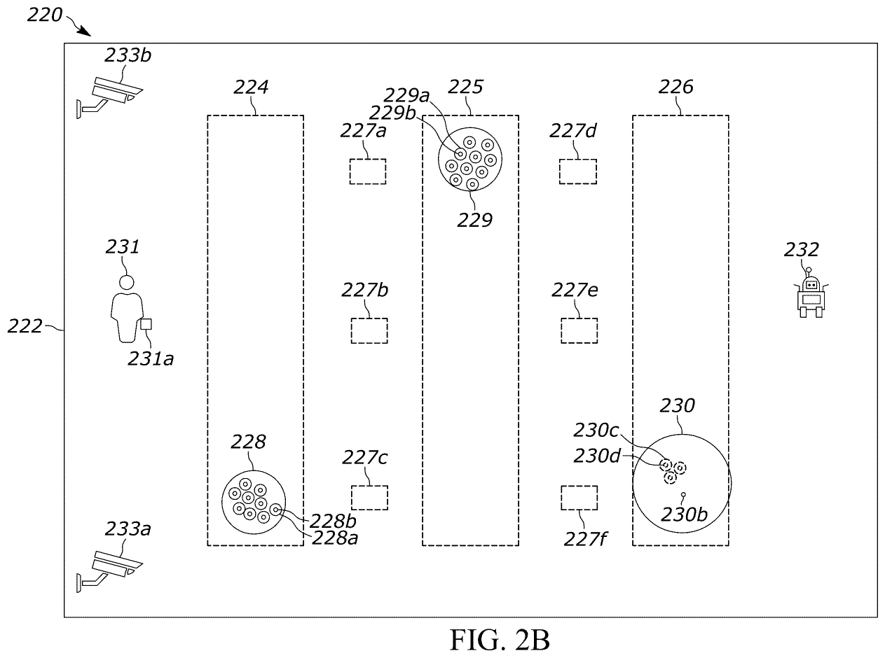

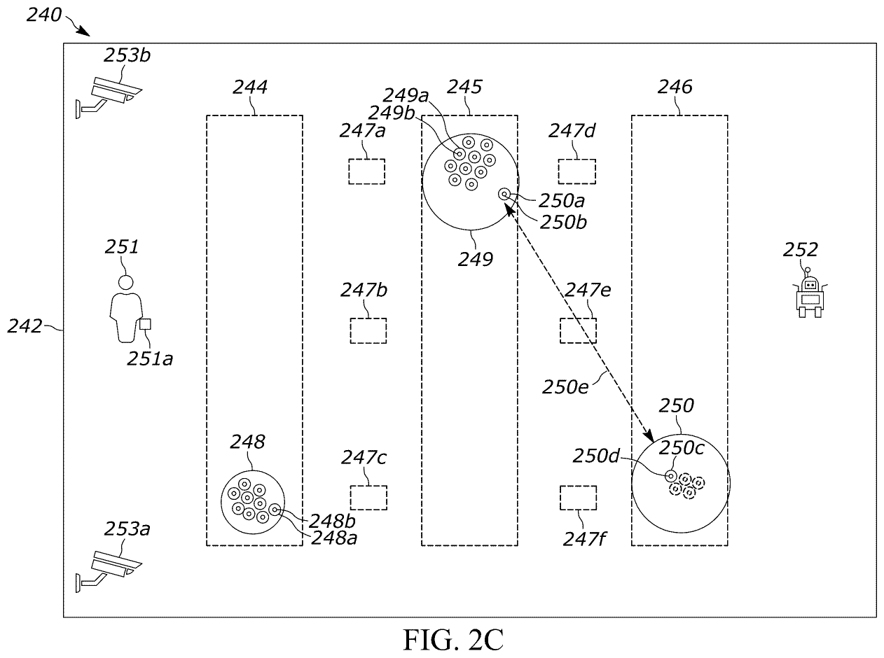

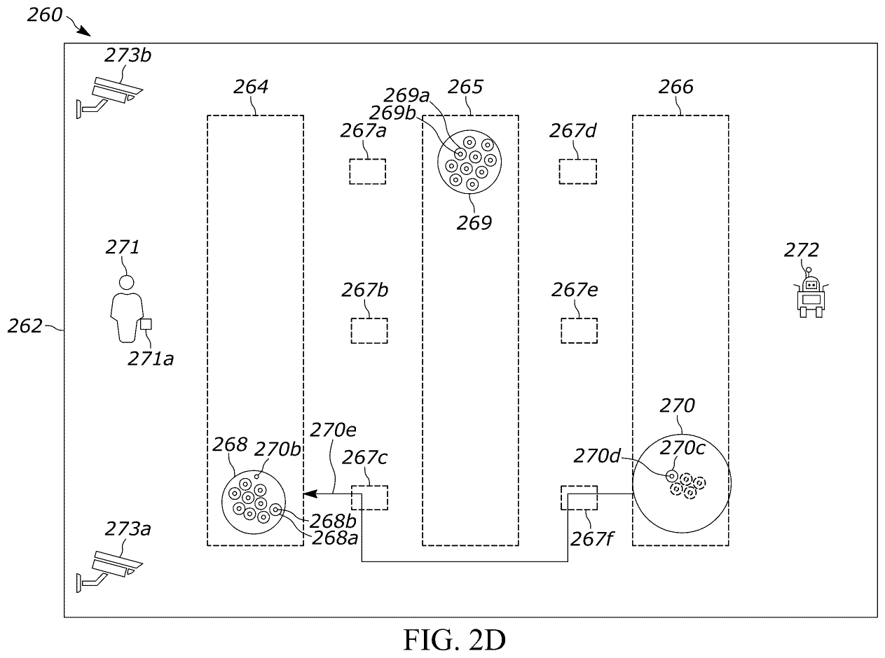

To illustrate the implementation and leveraging of the misplaced tag identification techniques described herein, FIGS. 2A-2D depict several example scenarios featuring a tag and the corresponding asset located within an environment, in accordance with various embodiments described herein. For example, FIG. 2A depicts a first example scenario 200 in which a representative tag 210b and associated asset 210a are located within a cluster 210 of similarly grouped items/tags that has a low cluster size, in accordance with various embodiments described herein. The first example scenario 200 includes an environment 202 which, for the purposes of discussion only, may be a retail environment that includes multiple, different assets of various types and attributes. The environment 202 includes multiple aisles 204, 205, 206 that each include at least one cluster of assets. For example, the first aisle 204 includes a first cluster 208 of assets (e.g., asset 208a) and their associated tags (e.g., tag 208b), the second aisle 205 includes a second cluster 209 of assets (e.g., asset 209a) and their associated tags (e.g., tag 209b), and the third aisle 206 includes a third cluster 210 of assets (e.g., asset 210a) and their associated tags (e.g., tag 210b). The environment 202 further includes a plurality of readers 207a, 207b, 207c, 207d, 207e, and 207f that may each have a corresponding coverage area (not shown), within which, the readers 207a-207f may receive signals from tags located in the coverage area.

As illustrated in FIG. 2A, the environment 202 further includes a user (e.g., a retail employee) 211, an autonomous robot 212, and cameras 213a, 213b that may comprise a camera system. Each of the user 211, the robot 212, and the cameras 213a, 213b may be configured to move, rotate, and/or otherwise adjust their respective positions/orientations to, for example, capture image data of one or more tags/assets and/or relocate one or more tags/assets. For example, the user 211 may have (e.g., carry) a corresponding user device 211a, such as a mobile phone or scanning/imaging tool, that is configured to capture image data. The autonomous robot 212 may include imaging hardware (e.g., integrated or otherwise coupled cameras) configured to capture image data of the one or more assets/tags, as well as movement hardware (e.g., motors, wheels, etc.) configured to enable the robot 212 to maneuver through the environment 202. The cameras 213a, 213b may be or include RGB cameras and/or other video hardware, as well as automatic adjustment components (e.g., actuators, motors, zoom actuators/motors, etc.) that may adjust the orientation of the cameras 213a, 213b to adjust their respective fields of view (FOVs) and thereby capture image data of the one or more assets/tags.

In the first example scenario 200, the third cluster 210 includes the asset 210a and the corresponding tag 210b and may optionally include another asset 210c and another corresponding tag 210d. Thus, the asset 210a and the corresponding tag 210b may be the only/last tag/asset included as part of the third cluster 210. When a reader (e.g., reader 207f) receives a signal from the tag 210b, the server (not shown) (e.g., server 110) may determine that the tag 210b satisfies the cluster threshold because it transmitted the only signal with an estimated location corresponding to the third cluster 210 location/boundaries and there are other clusters (e.g., first cluster 208) within the environment 202 that have assets (e.g., asset 208a) in the same group as the asset 210a corresponding with the tag 210b.

The instructions (e.g., 110b2) may cause the server to transmit instructions that cause one or more of the user 211 (e.g., via user device 211a), the robot 212, and/or the cameras 213a, 213b to capture image data of the asset 210a to confirm that the tag 210b is affixed to and/or otherwise collocated with the asset 210a. When the captured image data indicates that the tag 210b is collocated with the asset 210a, the misplaced tag identification instructions (e.g., 110b2) may cause the server to evaluate why the tag 210b is the only/last tag in the third cluster 210.

For example, the server may analyze the movement patterns of other assets that were previously included in the third cluster 210 to determine a rate of movement (e.g., sale) of such assets over time. The server may also analyze the movement patterns of assets from other clusters including assets from the same group as the third cluster 210 (e.g., the first cluster 208) to compare the movement patterns of the assets in the third cluster 210 with those of the first cluster 208. If, for example, the assets from the third cluster 210 have recently (e.g., over the course of 6 hours) been moved from the third cluster 210 location, then the server may determine that the third cluster 210 location (e.g., the display location associated with the third cluster 210) is an advantageous location (e.g., to motivate sales/purchases) for the assets in the group associated with the third cluster 210 and the first cluster 208. If, on the other hand, the asset 210a has been located at the third cluster 210 location for a significant period of time (e.g., ten hours) and no other assets from the third cluster 210 were moved during that period of time, the server may determine that the third cluster 210 location is not an advantageous location for the assets in the group associated with the third cluster 210 and the first cluster 208. Similarly, if the asset 210a has remained as the last asset at the third cluster 210 location for a significant period of time while assets (e.g., asset 208a) from the first cluster 208 have been moved (e.g., sold) from the first cluster 208 location during the same period of time, the server may determine that the first cluster 208 location is a more advantageous location than the third cluster 210 location for the assets in the group associated with the third cluster 210 and the first cluster 208.

In any event, the instructions (e.g., 110b2) may further cause the server to generate an alert instruction that is related to the evaluation(s) made by the server related to why the tag 210b is the only/last tag in the third cluster 210. For example, when the server determines that the third cluster 210 location is not advantageous for the assets in the group associated with the third cluster 210 and the first cluster 208, the alert instruction may indicate that a user (e.g., user 211) or autonomous robot (e.g., robot 212) should relocate the asset 210a associated with the tag 210b from the cluster location (e.g., third cluster 210) to another cluster location associated with another cluster (e.g., first cluster 208) that includes assets (e.g., asset 208a) included in a same group as the asset 210a associated with the tag 210b. As another example, when the server determines that the third cluster 210 location is advantageous for the assets in the group associated with the third cluster 210 and the first cluster 208, the alert instruction may indicate that the user or robot should relocate the assets (e.g., asset 208a) from the cluster location of the first cluster 208 to the cluster location of the third cluster 210.

As a practical example, the systems described herein may divide tags (e.g., tag 210b) associated with the asset “men's blue cotton V-necked T-shirts” (e.g., asset 210a) within the environment 200 into a particular group. The systems may then, based on the location estimates for the tags associated with the T-shirts, separate the tags into clusters of tags that include sets of tags that are physically close together within the environment 200. If one cluster (e.g., third cluster 210) contains a single tag 210b, the systems described herein may create a task, such as generating/transmitting an instruction to a user device 211a, to send the user 211, the autonomous robot 212, and/or the camera system 213a, 213b to check whether the tag 210b is still on the T-shirt 210a. When it is confirmed that the tag 210b is still on the T-shirt 210a, and there is another larger cluster (e.g., first cluster 208) of men's blue cotton V-necked T-shirts elsewhere within the environment 200, the systems described herein may generate and transmit an alert indication (e.g., to the user device 211a) that directs, e.g., the user 211 to move the single T-shirt 210a to the larger cluster's (e.g., 208) location.

As mentioned, and in certain instances, the asset 210a and the corresponding tag 210b may be included as part of the third cluster 210 with the asset 210c and tag 210d, such that the asset 210a and tag 210b are not technically the only/last asset/tag in the cluster 210 (e.g., one of two/three/five remaining assets/tags in the cluster 210). Nevertheless, in certain embodiments, the instructions (e.g., misplaced tag identification instructions 110b2) may still cause the server to determine that the tag 210b (i) satisfies the first location threshold and (ii) satisfies the second location threshold, and to generate alert instructions accordingly, as described previously.

FIG. 2B depicts a second example scenario 220 in which a representative tag 230b located within a cluster 230 of similarly grouped tags/items is not co-located with the associated asset, in accordance with various embodiments described herein. The second example scenario 220 includes an environment 222 which, for the purposes of discussion only, may be a retail environment that includes multiple, different assets of various types and attributes. The environment 222 includes multiple aisles 224, 225, 226 that each include at least one cluster of assets. For example, the first aisle 224 includes a first cluster 228 of assets (e.g., asset 228a) and their associated tags (e.g., tag 228b), the second aisle 225 includes a second cluster 229 of assets (e.g., asset 229a) and their associated tags (e.g., tag 229b), and the third aisle 226 includes a third cluster 230 of assets (e.g., asset 230a) and their associated tags (e.g., tag 230b). The environment 222 further includes a plurality of readers 227a, 227b, 227c, 227d, 227e, and 227f that may each have a corresponding coverage area (not shown), within which, the readers 227a-227f may receive signals from tags located in the coverage area.

As illustrated in FIG. 2B, the environment 222 further includes a user (e.g., a retail employee) 231, an autonomous robot 232, and cameras 233a, 233b that may comprise a camera system. Each of the user 231, the robot 232, and the cameras 233a, 233b may be configured to move, rotate, and/or otherwise adjust their respective positions/orientations to, for example, capture image data of one or more tags/assets and/or relocate one or more tags/assets. For example, the user 231 may have (e.g., carry) a corresponding user device 231a, such as a mobile phone or scanning/imaging tool, that is configured to capture image data. The autonomous robot 232 may include imaging hardware (e.g., integrated or otherwise coupled cameras) configured to capture image data of the one or more assets/tags, as well as movement hardware (e.g., motors, wheels, etc.) configured to enable the robot 232 to maneuver through the environment 222. The cameras 233a, 233b may be or include RGB cameras and/or other video hardware, as well as automatic adjustment components (e.g., actuators, motors, zoom actuators/motors, etc.) that may adjust the orientation of the cameras 233a, 233b to adjust their respective FOVs and thereby capture image data of the one or more assets/tags.

In the first example scenario 220, the third cluster 230 includes the tag 230b and may optionally include another set of assets and corresponding tags (collectively referenced as 230c and 230d, respectively). Thus, the tag 230b is not affixed and/or otherwise proximate to a corresponding asset within the third cluster 230 and may be the last/only tag within the third cluster 230. When a reader (e.g., reader 207f) receives a signal from the tag 230b, the server (not shown) (e.g., server 110) may determine that the tag 230b satisfies the cluster threshold because it transmitted the only signal with an estimated location corresponding to the third cluster 230 location/boundaries and there are other clusters (e.g., second cluster 209) within the environment that have assets (e.g., asset 229a) in the same group as the asset corresponding with the tag 230b.

The instructions (e.g., 110b2) may cause the server to transmit instructions that cause one or more of the user 231 (e.g., via user device 231a), the robot 232, and/or the cameras 233a, 233b to attempt to capture image data of the asset to confirm whether the tag 230b is affixed to and/or otherwise collocated with the asset. When the captured image data indicates that the tag 230b is not collocated with the asset, the misplaced tag identification instructions (e.g., 110b2) may cause the server to determine that the tag 230b fails to satisfy the first location threshold (e.g., relative to the corresponding asset) and satisfies the second location threshold (e.g., relative to the third cluster 230 location). Thus, the instructions may further cause the server to generate an alert instruction that includes a removal indication corresponding to the tag 230b. As the asset corresponding to the tag 230b is missing, the tag 230b may be discarded and removed from the tag database (e.g., 110b1). When the server generates the alert instruction, the server may automatically remove the tag's 230b data entry from the tag database or transmit the alert instructions to the user device 231a and/or the autonomous robot 232 to cause the user device 231a (and/or the autonomous robot 232) to remove the tag's 230b data entry from the tag database, and/or the alert instruction may include an indication for the user device 231a and/or the robot 232 that the tag's 230b data entry has been removed from the tag database, in accordance with the removal indication. The alert instruction may also indicate the tag's 230b estimated location and may include instructions for the user 231 and/or the autonomous robot 232 to remove the tag 230b from the third cluster 230 location and dispose/discard the tag 230b appropriately.

FIG. 2C depicts a third example scenario 240 in which a representative tag 250b and associated asset 250a are not located within a cluster 250 of similarly grouped tags/assets, in accordance with various embodiments described herein. The third example scenario 240 includes an environment 242 which, for the purposes of discussion only, may be a retail environment that includes multiple, different assets of various types and attributes. The environment 242 includes multiple aisles 244, 245, 246 that each include at least one cluster of assets. For example, the first aisle 244 includes a first cluster 248 of assets (e.g., asset 248a) and their associated tags (e.g., tag 248b), the second aisle 245 includes a second cluster 249 of assets (e.g., asset 249a) and their associated tags (e.g., tag 249b), and the third aisle 246 includes a third cluster 250 of assets (e.g., asset 250c) and their associated tags (e.g., tag 250d). The environment 242 further includes a plurality of readers 247a, 247b, 247c, 247d, 247e, and 247f that may each have a corresponding coverage area (not shown), within which, the readers 247a-247f may receive signals from tags located in the coverage area.

As illustrated in FIG. 2C, the environment 242 further includes a user (e.g., a retail employee) 251, an autonomous robot 252, and cameras 253a, 253b that may comprise a camera system. Each of the user 251, the robot 252, and the cameras 253a, 253b may be configured to move, rotate, and/or otherwise adjust their respective positions/orientations to, for example, capture image data of one or more tags/assets and/or relocate one or more tags/assets. For example, the user 251 may have (e.g., carry) a corresponding user device 251a, such as a mobile phone or scanning/imaging tool, that is configured to capture image data. The autonomous robot 252 may include imaging hardware (e.g., integrated or otherwise coupled cameras) configured to capture image data of the one or more assets/tags, as well as movement hardware (e.g., motors, wheels, etc.) configured to enable the robot 252 to maneuver through the environment 242. The cameras 253a, 253b may be or include RGB cameras and/or other video hardware, as well as automatic adjustment components (e.g., actuators, motors, zoom actuators/motors, etc.) that may adjust the orientation of the cameras 253a, 253b to adjust their respective FOVs and thereby capture image data of the one or more assets/tags.

In the first example scenario 240, the asset 250a of a first group is collocated with the corresponding tag 250b and they are collectively located away from the third cluster 250 location (as indicated by the arrow 250e) and are instead located within the second cluster 249 location with assets (e.g., 249a) that are in a second group that is different from the first group of the asset 250a. Thus, the signals received from the tag 250b may indicate that the asset 250a and tag 250b are not located in a cluster of similarly grouped assets, such that the tag 250b is effectively a last/only tag within a new cluster defined by the tag's 250b location. When a reader (e.g., reader 247d) receives a signal from the tag 250b, the server (not shown) (e.g., server 110) may determine that the tag 250b satisfies the cluster threshold because it transmitted the only signal for an asset in the first group with an estimated location that does not correspond to the third cluster 250 location/boundaries and there are other clusters (e.g., third cluster 250) within the environment that have assets (e.g., asset 250c) and tags (e.g., tag 250d) in the same group as the asset 250a corresponding with the tag 250b.

The instructions (e.g., 110b2) may cause the server to transmit instructions that cause one or more of the user 251 (e.g., via user device 251a), the robot 252, and/or the cameras 253a, 253b to capture image data of the asset to confirm whether the tag 250b is affixed to and/or otherwise collocated with the asset 250a. When the captured image data indicates that the tag 250b is collocated with the asset 250a, the misplaced tag identification instructions (e.g., 110b2) may cause the server to determine that the tag 250b satisfies the first location threshold (e.g., relative to the asset 250a) and fails to satisfy the second location threshold (e.g., relative to the third cluster 250 location). Thus, the instructions may further cause the server to generate an alert instruction that includes an indication to relocate the asset 250a associated with the tag 250b to the third cluster 250 location. The user 251 and/or autonomous robot 252 may then retrieve the asset 250a and relocate the asset 250a to the third cluster 250 location.

FIG. 2D depicts a fourth example scenario 260 in which a representative tag 270b is neither co-located with the associated asset (not shown) nor within a cluster 270 of similarly grouped tags/assets, in accordance with various embodiments described herein. The fourth example scenario 260 includes an environment 262 which, for the purposes of discussion only, may be a retail environment that includes multiple, different assets of various types and attributes. The environment 262 includes multiple aisles 264, 265, 266 that each include at least one cluster of assets. For example, the first aisle 264 includes a first cluster 268 of assets (e.g., asset 268a) and their associated tags (e.g., tag 268b), the second aisle 265 includes a second cluster 269 of assets (e.g., asset 269a) and their associated tags (e.g., tag 269b), and the third aisle 266 includes a third cluster 270 of assets (e.g., asset 270c) and their associated tags (e.g., tag 270d). The environment 262 further includes a plurality of readers 267a, 267b, 267c, 267d, 267e, and 267f that may each have a corresponding coverage area (not shown), within which, the readers 267a-267f may receive signals from tags located in the coverage area.

As illustrated in FIG. 2D, the environment 262 further includes a user (e.g., a retail employee) 271, an autonomous robot 272, and cameras 273a, 273b that may comprise a camera system. Each of the user 271, the robot 272, and the cameras 273a, 273b may be configured to move, rotate, and/or otherwise adjust their respective positions/orientations to, for example, capture image data of one or more tags/assets and/or relocate one or more tags/assets. For example, the user 271 may have (e.g., carry) a corresponding user device 271a, such as a mobile phone or scanning/imaging tool, that is configured to capture image data. The autonomous robot 272 may include imaging hardware (e.g., integrated or otherwise coupled cameras) configured to capture image data of the one or more assets/tags, as well as movement hardware (e.g., motors, wheels, etc.) configured to enable the robot 272 to maneuver through the environment 262. The cameras 273a, 273b may be or include RGB cameras and/or other video hardware, as well as automatic adjustment components (e.g., actuators, motors, zoom actuators/motors, etc.) that may adjust the orientation of the cameras 273a, 273b to adjust their respective FOVs and thereby capture image data of the one or more assets/tags.

In the first example scenario 260, the asset of a first group is not collocated with the corresponding tag 270b and the tag 270b is located away from the third cluster 270 location (as indicated by the path 270e) and is instead located within the first cluster 268 location with assets (e.g., 268a) that are in a second group that is different from the first group of the asset associated with the tag 270b. Thus, the signals received from the tag 270b may indicate that the asset and tag 270b are not located in a cluster of similarly grouped assets, such that the tag 270b is effectively a last/only tag within a new cluster defined by the tag's 270b location. When a reader (e.g., reader 267c) receives a signal from the tag 270b, the server (not shown) (e.g., server 110) may determine that the tag 270b satisfies the cluster threshold because it transmitted the only signal for an asset in the first group with an estimated location that does not correspond to the third cluster 270 location/boundaries and there are other clusters (e.g., third cluster 270) within the environment that have assets (e.g., asset 270c) and tags (e.g., tag 270d) in the same group as the asset corresponding with the tag 270b.

The instructions (e.g., 110b2) may cause the server to transmit instructions that cause one or more of the user 271 (e.g., via user device 271a), the robot 272, and/or the cameras 273a, 273b to attempt to capture image data of the asset to confirm whether the tag 270b is affixed to and/or otherwise collocated with the asset. When the captured image data indicates that the tag 270b is not collocated with the asset 270a, the misplaced tag identification instructions (e.g., 110b2) may cause the server to determine that the tag 270b fails to satisfy the first location threshold (e.g., relative to the asset) and fails to satisfy the second location threshold (e.g., relative to the third cluster 270 location). Thus, the instructions may further cause the server to generate an alert instruction that includes an indication of (i) a time when a respective signal from the tag 270b indicated a different location of the tag 270b from a prior signal from the tag 270b and (ii) a path (e.g., path 270e) of the tag 270b from a current location (e.g., in the first cluster 268 location) of the tag 270b to the cluster location (e.g., third cluster 270 location).

For example, assume the tag 270b transmitted a first signal indicating its movement from the third cluster 270 location one minute prior to the current signal transmission from the tag 270b indicating its current location within the first cluster 268 boundary. The server may include the timestamp of the first signal transmission in the alert instruction to inform the user 271 and/or the autonomous robot 272 when the asset associated with the tag 270b was first picked up. The server may also evaluate the estimated locations of the tag 270b at every time instance when a signal was received from the tag 270b between the first signal transmission and the current signal transmission to determine an approximate path the asset took before the tag 270b was eventually placed in its current location within the first cluster 268 boundary. The server may thereby determine the path 270e taken by the tag 270b, and by extension, the corresponding asset, by stitching the tag's 270b estimated locations together, and thereby give the user 271 and/or the autonomous robot 272 a set of locations to check for the asset. If the user 271 and/or the autonomous robot 272 cannot find the asset, the instructions (e.g., 110b2) may further cause the server to indicate that the asset was likely stolen, and to elevate the status of the asset associated with the tag 270b to additional personnel (e.g., asset management teams, police—not shown) for further investigation. When elevating the status of the asset, the server may also include the timestamp and path 270e information included as part of the alert instruction. Thus, the alert instruction may include all of this information (e.g., current tag 270b location, corresponding asset group/original cluster (third cluster 270), path 270e, timestamp information), and transmitting the alert instruction may include actions, such as alerting the user 271 and/or the autonomous robot 272 and/or elevating the status of the asset to additional personnel.

As a practical example, assume that the user 271 is sent to check/verify the location of a cluster (e.g., first cluster 268) containing a single tag (e.g., tag 270b) within the group of tags associated with “men's blue cotton V-necked T-shirts”. Upon arrival, the user 271 may determine that the tag 270b is no longer on a ““man's blue cotton V-necked T-shirt”, and the tag 270b is currently far from the location (e.g., third cluster 270) where “men's blue cotton V-necked T-shirts” are stocked. In this scenario, the systems described herein may generate and transmit an alert instruction to an asset protection team that includes the times (e.g., timestamps) and locations (e.g., as determined based on signals transmitted by the tag over time) corresponding to the path (e.g., path 270e) the tag 270b took to prior to reaching its current location (e.g., within the first cluster 268. Using this information from the alert instruction, the members of the asset protection team may, for example, check video footage (e.g., captured by the cameras 273a, 273b) at the times and locations indicated in the alert instruction for evidence of theft.

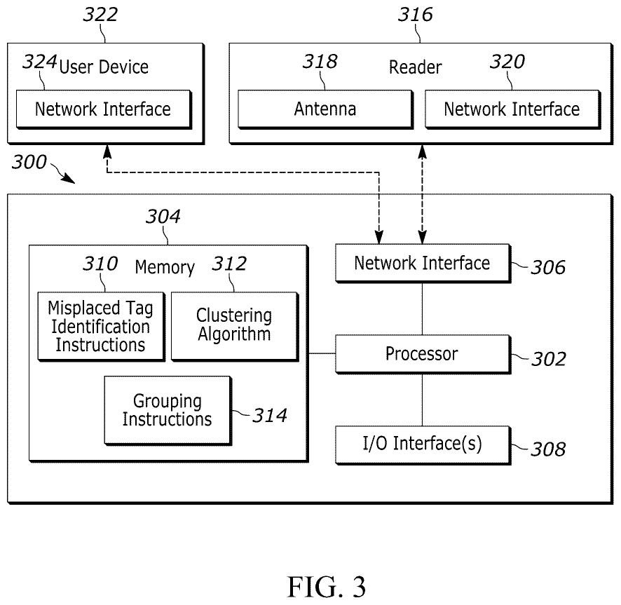

FIG. 3 is a block diagram representative of an example logic circuit capable of implementing, for example, the example server 110 and/or a combination of the server 110, the first reader 102, and/or the Nth reader 104 of FIG. 1. The example logic circuit of FIG. 3 is a processing platform 300 capable of executing instructions to, for example, implement operations of the example methods described herein, as may be represented by the flowcharts of the drawings that accompany this description. Other example logic circuits capable of, for example, implementing operations of the example methods described herein include field programmable gate arrays (FPGAs) and application specific integrated circuits (ASICs).

The example processing platform 300 of FIG. 3 includes a processor 302 such as, for example, one or more microprocessors, controllers, and/or any suitable type of processor. The example processing platform 300 of FIG. 3 includes memory (e.g., volatile memory, non-volatile memory) 304 accessible by the processor 302 (e.g., via a memory controller). The example processor 302 interacts with the memory 304 to obtain, for example, machine-readable instructions stored in the memory 304 corresponding to, for example, the operations represented by the flowchart(s) of this disclosure. Additionally, or alternatively, machine-readable instructions corresponding to the example operations described herein may be stored on one or more removable media (e.g., a compact disc (CD), a digital versatile disc (DVD), removable flash memory, etc.) that may be coupled to the processing platform 300 to provide access to the machine-readable instructions stored thereon.

The example processing platform 300 of FIG. 3 includes one or more communication interfaces such as, for example, one or more network interfaces 306, and/or one or more input/output (I/O) interfaces 308. The communication interface(s) may enable the processing platform 300 of FIG. 3 to communicate with, for example, a reader 316 and/or another device, system, host system (e.g., an inventory management system, a POS station, etc.), datastore, database, and/or any other machine.

The example processing platform 300 of FIG. 3 may include the network interface(s) 306 to enable communication with other machines (e.g., an inventory management system, a POS station, etc.) via, for example, one or more networks. The example network interface(s) 306 include any suitable type of communication interface(s) (e.g., wired and/or wireless interfaces) configured to operate in accordance with any suitable communication protocol(s). Example network interfaces 306 include a TCP/IP interface, a Wi-Fi™ transceiver (e.g., according to the IEEE 802.11x family of standards), an Ethernet transceiver, a cellular network radio, a satellite network radio, or any other suitable interface based on any other suitable communication protocols or standards.

For example, the network interface(s) 306 may enable the processing platform 300 to communicate with the reader 316 (e.g., via network interface 320) to receive tag signals, location estimates associated with the tags, and/or other data the reader 316 determines/generates based on tag signals received via the antenna 318. The processing platform 300 may then analyze this received data using, for example, the misplaced tag identification instructions 310 and/or the clustering algorithm 312 to determine one or more values (e.g., clusters of tags/assets, whether an asset/tag satisfies one or more location thresholds, etc.) associated with the tag data received from the reader 316. The processing platform 300 may further transmit instructions to the reader 316 for subsequent transmission to one or more tags via the antenna 318 and/or may transmit instructions (e.g., alert instructions) to other devices, such as an administrator workstation (not shown) or other user device(s) 322. For example, the processing platform 300 may analyze tag signal data received from the reader 316 by executing the misplaced tag identification instructions 310, determine that a tag is the only tag remaining in a particular cluster, and transmit an alert instruction to the user device 322 indicating that the asset/tag should be relocated to another cluster of similarly grouped assets/tags or that assets/tags from another such cluster should be relocated to the particular cluster with the single remaining asset/tag.

The example processing platform 300 of FIG. 3 may include the input/output (I/O) interface(s) 308 (e.g., a Bluetooth® interface, a near-field communication (NFC) interface, a universal serial bus (USB) interface, a serial interface, an infrared interface, etc.) to (1) enable receipt of user input (e.g., from a touch screen, keyboard, mouse, touch pad, joystick, trackball, microphone, button, etc.), (2) communicate output data (e.g., groups/clusters of assets/tags, alert instructions, data, images, etc.) to a user (e.g., via a display, speaker, printer, haptic device, etc.), and/or (3) interact with other components of the processing platform 300 (e.g., parameters of misplaced tag identification instructions 310, clustering algorithm 312, etc.).

The memory 304 stores misplaced tag identification instructions 310, the clustering algorithm 312, and the grouping instructions 314, which may enable performance of various tag grouping/clustering/identification functionalities described herein. For example, the processor 302 may access the memory 304 to execute the clustering algorithm 312. When the processor 302 receives estimated tag locations and/or information from which to determine such tag location estimates, the clustering algorithm 312 may cause the processor 302 to determine one or more clusters of tags based on the estimated tag locations. Similarly, the processor 302 may receive one or more assets, one or more asset types (e.g., cooler, pillow, jeans), and one or more asset attributes (e.g., color, brand, etc.) from the user device 322. The processor 302 may then execute the grouping instructions 314 to determine similarity values for each respective pair of assets and/or some subset of the assets to determine groups for each of the assets and/or tags associated with the assets.

Of course, it should be appreciated that, while the various components of the example processing platform 300 (e.g., processors 302, memory 304, etc.) are illustrated in FIG. 3 as single components, the example processing platform 300 may include multiple of each of the components. Further, the example processing platform 300 may include additional and/or alternate components, in various possible aspects.

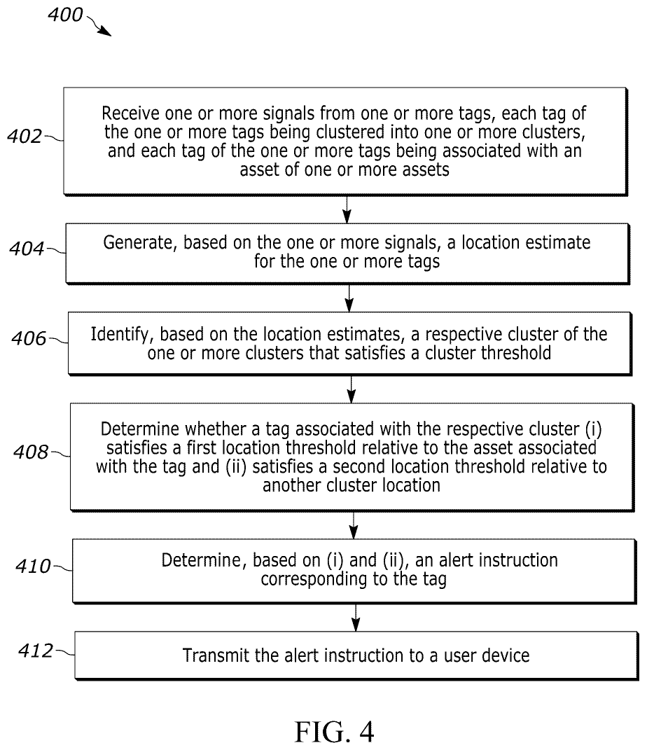

FIG. 4 is a flowchart representative of a method 400 for automated identification of misplaced tags, in accordance with embodiments described herein. Generally, and as described herein, the method 400 for automated identification of misplaced tags may cause the server 110, the first reader 102, and/or the Nth reader 104 to, e.g., receive signals from one or more tags (e.g., tags 106a, 107a, 108a), generate location estimates for the tags, identify respective clusters that satisfy the cluster threshold(s), determine whether tags associated with the respective clusters satisfy location thresholds relative to the assets and cluster locations associated with the tags, determine alert instructions corresponding to the tags, and/or transmit the alert instructions to a user device. It is to be understood that any of the steps of the method 400 may be performed by, for example, the server 110, the first reader 102, the Nth reader 104, the tags (e.g., tags 106a, 107a, 108a), and/or any other suitable components or combinations thereof discussed herein.

At block 402, the method 400 includes receiving one or more signals from one or more tags, each tag of the one or more tags being clustered into one or more clusters. Each tag of the one or more tags may be associated with an asset of one or more assets. The method 400 further includes generating, based on the one or more signals, a location estimate for the one or more tags (block 404). The method 400 further includes identifying, based on the location estimates, a respective cluster of the one or more clusters that satisfies a cluster threshold (block 406).

The method 400 further includes determining whether a tag associated with the respective cluster (i) satisfies a first location threshold relative to the asset associated with the tag and (ii) satisfies a second location threshold relative to another cluster location (block 408). The method 400 further includes determining, based on (i) and (ii), an alert instruction corresponding to the tag (block 410). The method 400 further includes transmitting the alert instruction to a user device (block 412).

In certain embodiments, the method 400 further includes grouping, based on an associated asset of the one or more assets, each tag of the one or more tags into one or more groups; and wherein each signal of the one or more signals at least one of: (i) indicates a group of the one or more groups associated with the respective asset or (ii) causes retrieval of an indication of the group associated with the respective asset.

In certain embodiments, each asset of the one or more assets includes an asset identifier that indicates (i) an asset type and (ii) an asset attribute, and the method 400 further includes grouping each tag of the one or more tags into the one or more groups by determining, for each asset of the one or more assets based on the asset type and the asset attribute, a similarity value between each pair of assets from the one or more assets; and grouping, based on the similarity values, each tag of the one or more tags into the one or more groups.

In certain embodiments, the method 400 further includes clustering, by a distance limit clustering algorithm based on the location estimates of tags within respective groups of the one or more groups, the tags within the respective groups into the one or more clusters; and wherein the distance limit clustering algorithm compares respective distances of each tag in a respective group to one or more other tags in the respective group to a distance threshold when clustering within each group.

In certain embodiments, the distance limit clustering algorithm comprises at least one of: (i) an Agglomerative Hierarchical Clustering algorithm or (ii) a Density-Based Spatial Clustering of Applications with Noise (DBSCAN) algorithm.

In certain embodiments, the method 400 further includes identifying that the respective cluster satisfies the cluster threshold by: determining that the tag is the only tag included in the respective cluster; and determining that a respective group corresponding to the respective cluster also corresponds to another cluster of the one or more clusters.

In certain embodiments, the cluster location is a first cluster location, and the method 400 further to determining the alert instruction by: determining that the tag (i) satisfies the first location threshold and (ii) satisfies the second location threshold; and wherein the alert instruction comprises an indication to either: (i) relocate the asset associated with the tag from the first cluster location to a second cluster location associated with another cluster of the one or more clusters, the another cluster comprising respective assets of the one or more assets included in a same group of the one or more groups as the asset associated with the tag, or (ii) relocate the respective assets from the second cluster location to the first cluster location.

In certain embodiments, the method 400 further includes determining the alert instruction by: determining that the tag (i) satisfies the first location threshold and (ii) fails to satisfy the second location threshold; and wherein the alert instruction comprises an indication to relocate the asset associated with the tag to the cluster location.

In certain embodiments, the method 400 further includes determining the alert instruction by: determining that the tag (i) fails to satisfy the first location threshold and (ii) fails to satisfy the second location threshold; and wherein the alert instruction comprises an indication of (i) a time when a respective signal from the tag indicated a different location of the tag from a prior signal from the tag and (ii) a path of the tag from a current location of the tag to the cluster location.

In certain embodiments, the method 400 further includes determining the alert instruction by: determining that the tag (i) fails to satisfy the first location threshold and (ii) satisfies the second location threshold; generating the alert instruction to comprise a removal indication corresponding to the tag; and
wherein transmitting the alert instruction to the user device causes the user device to remove the tag from a tag database in accordance with the removal indication.

In certain embodiments, the tag is a first tag, and the method 400 further includes generating a misplaced tag list that includes the first tag and a second tag of the one or more tags; determining a respective location of the second tag based on the respective signal corresponding to the second tag; determining whether (i) a prior signal corresponding to the second tag satisfies a time threshold and (ii) the respective location of the second tag satisfies a historical location threshold; and responsive to determining, for the second tag, that the prior signal fails to satisfy the time threshold and the respective location fails to satisfy the historical location threshold, removing the second tag from the misplaced tag list.

In certain embodiments, the method 400 further includes capturing image data of a respective location corresponding to the respective cluster; and analyzing the captured image data to determine whether the tag (i) satisfies the first location threshold and (ii) satisfies the second location threshold.

In certain embodiments, the one or more tags are radio-frequency identification (RFID) tags, and the method 400 further includes receiving, at one or more RFID readers, the one or more signals from the one or more RFID tags; and generating, based on the one or more signals, the location estimates for the one or more tags, wherein the location estimates comprise three-dimensional (3D) locations for the one or more RFID tags.

In certain embodiments, the method 400 further includes determining whether the tag (i) satisfies the first location threshold and (ii) satisfies the second location threshold by: generating a direction instruction indicating directions to the location estimate of the tag based on a current location of at least one of: (i) a user, (ii) a device of the user, or (iii) an autonomous mobile device connected to the system; and transmitting the direction instruction to the user device, wherein the user device includes at least one of: (i) the device of the user or (ii) the autonomous mobile device; or generating, based on the location estimate of the tag, a control instruction configured to orient an imaging system to capture image data of the tag; and transmitting the control instruction to the imaging system to (i) orient the imaging system in accordance with the control instruction and (ii) capture the image data of the tag.

In certain embodiments, the method 400 further includes receiving location confirmation data corresponding to the current location of the tag from at least one of: (i) the user, (ii) the device of the user, (iii) the autonomous mobile device, or (iv) the imaging system; and determining whether the tag (i) satisfies the first location threshold and (ii) satisfies the second location based on the location confirmation data.

Of course, it is to be appreciated that the actions of the method 400 may be performed in any suitable order and any suitable number of times.

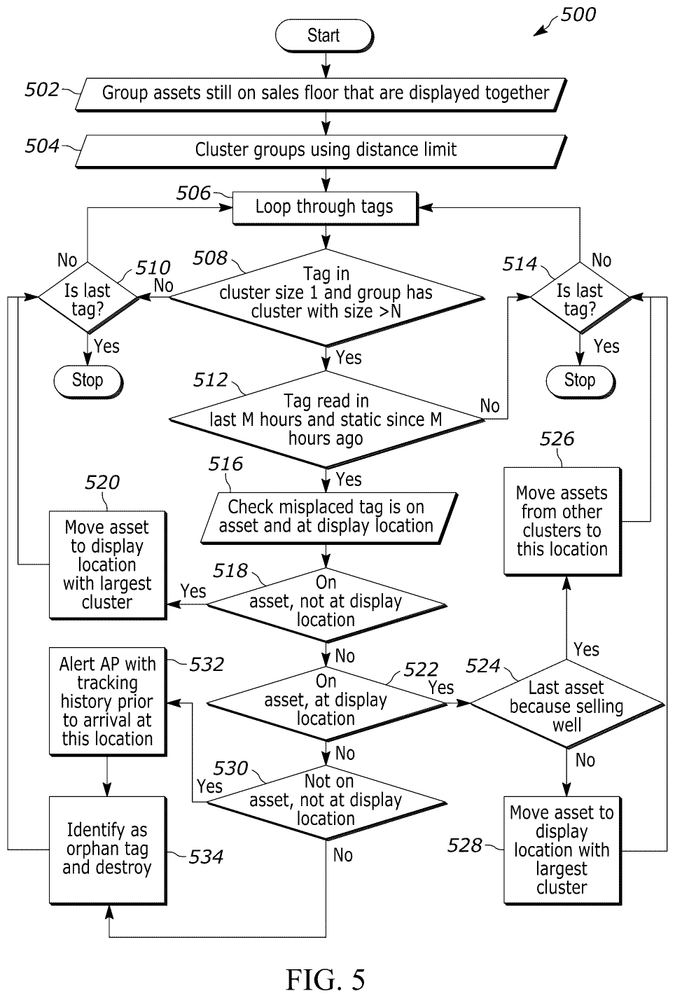

FIG. 5 is another flowchart representative of a method 500 for automated identification of misplaced tags, in accordance with embodiments described herein. Generally, and as described herein, the method 500 for automated identification of misplaced tags may cause the server 110, the first reader 102, and/or the Nth reader 104 to, e.g., receive signals from one or more tags (e.g., tags 106a, 107a, 108a), generate location estimates for the tags, identify respective clusters that satisfy the cluster threshold(s), determine whether tags associated with the respective clusters satisfy location thresholds relative to the assets and cluster locations associated with the tags, determine alert instructions corresponding to the tags, and/or transmit the alert instructions to a user device. It is to be understood that any of the steps of the method 500 may be performed by, for example, the server 110, the first reader 102, the Nth reader 104, the tags (e.g., tags 106a, 107a, 108a), and/or any other suitable components or combinations thereof discussed herein.

At block 502, the method 500 includes grouping assets together when those assets have a corresponding asset type and one or more asset attributes that are similar to other assets that are part of the group. The method 500 further includes clustering the groups of similar assets into one or more clusters using a clustering algorithm (e.g., a distance limit clustering algorithm) based on location estimates of the tags within respective groups of the one or more groups (block 504).

The method 500 further includes looping through each tag for which a data packet is received at a reader device (e.g., an RFID reader) (block 506). The method 500 further includes determining whether a particular tag is included in a cluster of size 1, indicating that the particular tag is the last/only tag included in the cluster, and that the group to which the asset (associated with the tag) belongs has at least one other cluster with a size that is greater than some integer value N, where N may be any suitable integer value (block 508). Thus, block 508 generally determines whether the cluster including the particular tag satisfies the cluster threshold, as described herein.

More generally, the actions associated with block 508 influence the alert instructions generated herein as a result of determining whether the cluster including the particular tag satisfies the cluster threshold. Namely, each alert instruction may include details that are dependent on whether the tag and its associated asset are collocated, and whether there is at least one alternative cluster in the group to which the tag belongs. For example, the alert instruction associated with block 520 includes details indicating to a user/autonomous robot to move the asset to a display location associated with a largest cluster of the group to which the asset belongs because the asset is collocated with its associated tag and is not at a display location for the asset.

If the systems described herein determine that the cluster including the particular tag does not satisfy one or both criteria of the cluster threshold (No branch of block 508), then the method 500 may further include determining whether the particular tag is the last tag for which a signal was received by the readers at a particular time instance (block 510). If the systems described herein determine that the tag is the last tag for which a signal was received (Yes branch of block 510), the method 500 may terminate (“Stop” block). However, if the systems described herein determine that the tag is not the last tag for which a signal was received (No branch of block 510), the method 500 may further include returning to block 506 to continue looping through the tags.

If the systems described herein determine that the cluster including the particular tag satisfies both criteria of the cluster threshold (Yes branch of block 508), then the method 500 may further include determining whether one or more readers received a signal transmission from the particular tag within a prior M hours and whether the particular tag's estimated location is static with respect to the location associated with the prior signal received within the prior M hours, where M is any suitable integer value (e.g., 24, 12, 6, 2, etc.) (block 512). If either of these conditions are not met (No branch of block 512), the method 500 may further include determining whether the particular tag is the last tag for which a signal was received by the readers at a particular time instance (block 514). If the systems described herein determine that the tag is the last tag for which a signal was received (Yes branch of block 514), the method 500 may terminate (“Stop” block). However, if the systems described herein determine that the tag is not the last tag for which a signal was received (No branch of block 514), the method 500 may further include returning to block 506 to continue looping through the tags.

If the systems described herein determine that a signal from the particular tag was received within the prior M hours and the estimated location of the particular tag has not changed in the prior M hours (Yes branch of block 512), the method 500 may further include checking that the misplaced tag is collocated with the corresponding asset and located at a display location (block 516). For example, the method 500 may include generating and transmitting an instruction to an individual, an autonomous robot, a camera system, and/or other suitable components described herein to capture image data and/or otherwise view the estimated location of the tag to confirm whether the tag is collocated with the asset and whether the tag is located at a display location associated with a cluster for that tag.

The method 500 further includes determining whether the particular tag is collocated with the asset and is not located at a display location for that asset (block 518). If the systems described herein determine that the particular tag is collocated with the asset and is not at a display location for the asset (Yes branch of block 518), the method 500 may further include generating/transmitting an alert instruction/indication to move the asset to a display location associated with a largest cluster of the group to which the asset belongs (block 520). The method 500 may further include proceeding to block 510 to determine whether the particular tag is the last tag for which a signal was received by the readers at a particular time instance.

If the systems described herein determine that either the particular tag is not collocated with the asset or is located at a display location (No branch of block 518), the method 500 may further include determining whether the particular tag is collocated with the asset and is located at a display location for that asset (block 522). If the systems described herein determine that the particular tag is collocated with the asset and is at a display location for the asset (Yes branch of block 522), the method 500 may further include determining whether the asset is a last asset of the cluster because the assets of the cluster are selling well (block 524). If the systems described herein determine that the asset is a last asset because the assets of the cluster are selling well (Yes branch of block 524), the method 500 may further include generating/transmitting an alert instruction/indication to move assets from another cluster to the display location associated with the cluster including the last asset (block 526). However, if the systems described herein determine that the asset is not a last asset because the assets of the cluster are selling well (No branch of block 524), the method 500 may further include generating/transmitting an alert instruction/indication to move the last assets from the cluster to a display location associated with a largest cluster of the group to which the asset belongs (block 528). In either case, the method 500 may further include proceeding to block 514 to determine whether the particular tag is the last tag for which a signal was received by the readers at a particular time instance.

If the systems described herein determine that the particular tag is not collocated with the asset and/or is not at a display location for the asset (No branch of block 522), the method 500 may further include determining whether the particular tag is not collocated with the asset and is not at a display location for the asset (block 530). If the systems described herein determine that the particular tag is not collocated with the asset and is not at a display location (Yes branch of block 530), then the method 500 may further include generating/transmitting an alert instruction to alert a user that indicates, for example, (i) a time when a respective signal from the particular tag indicated a different location of the particular tag from a prior signal from the particular tag and (ii) a path of the particular tag from a current location of the particular tag to the cluster location (block 532). After generating/transmitting the alert instruction and/or if the systems described herein determine that the particular tag is not collocated with the asset and is at a display location (No branch of block 530), then the method 500 may further include identifying the tag as an orphan tag and flagging the orphan tag for destruction (e.g., physically and/or removing associated data entries from tag database 110b1), as described herein (block 534). The method 500 may further include proceeding to block 510 to determine whether the particular tag is the last tag for which a signal was received by the readers at a particular time instance.

Of course, it is to be appreciated that the actions of the method 500 may be performed in any suitable order and any suitable number of times.

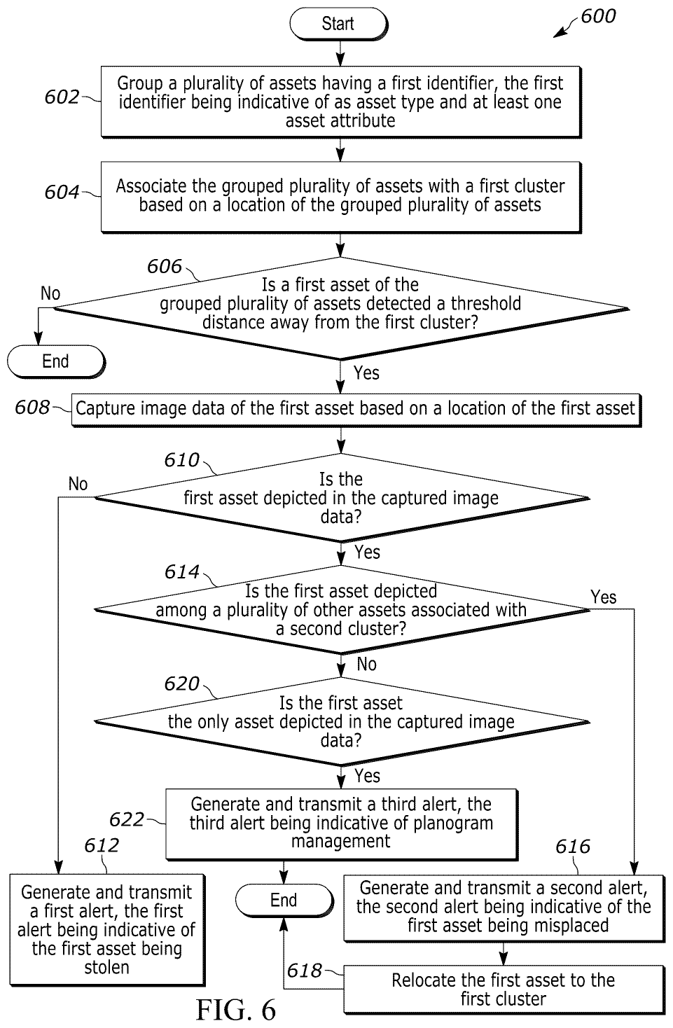

FIG. 6 is yet another flowchart representative of a method 600 for automated identification of misplaced tags, in accordance with embodiments described herein. Generally, and as described herein, the method 600 for automated identification of misplaced tags may cause the server 110, the first reader 102, and/or the Nth reader 104 to, e.g., receive signals from one or more tags (e.g., tags 106a, 107a, 108a), generate location estimates for the tags, identify respective clusters that satisfy the cluster threshold(s), determine whether tags associated with the respective clusters satisfy location thresholds relative to the assets and cluster locations associated with the tags, determine alert instructions corresponding to the tags, and/or transmit the alert instructions to a user device. It is to be understood that any of the steps of the method 600 may be performed by, for example, the server 110, the first reader 102, the Nth reader 104, the tags (e.g., tags 106a, 107a, 108a), and/or any other suitable components or combinations thereof discussed herein.

At block 602, the method 600 includes grouping a plurality of assets having a first identifier (block 602). The first identifier may be indicative of an asset type and at least one asset attribute, as discussed herein. The method 600 may further include associating the grouped plurality of assets with a first cluster based on a location of the grouped plurality of assets (block 604). For example, the location of the grouped plurality of assets within the first cluster may generally correspond to a display location for the assets within a retail environment.

The method 600 further includes determining whether the first asset is detected as being a threshold distance away from the first cluster (block 606). For example, the systems described herein may evaluate an estimated location of the first asset based on signal(s) received from the tag corresponding to the asset to determine a distance of the first asset from the first cluster. The systems described herein may then compare this distance to the threshold distance to determine whether the asset is at least the threshold distance away from the first cluster. If the systems described herein determine that the first asset is not at least the threshold distance away from the first cluster (No branch of block 606), the method 600 may terminate (e.g., “End” block).

However, if the systems described herein determine that the first asset is at least the threshold distance away from the first cluster (Yes branch of block 606), the method 600 may further include capturing image data of the first asset based on the estimated location of the first asset (block 608). Capturing the image data may include the systems described herein generating/transmitting an instruction or notification to an individual/user, an autonomous robot with imaging capabilities, a camera system, and/or any other suitable components described herein that may be configured to capture image data. The instruction/notification may indicate the estimated location of the first asset, may provide directions (e.g., for a user or autonomous robot) to navigate to the estimated location, and/or may cause the camera systems to adjust/reorient in a manner sufficient to bring the estimated location within the camera system FOV. In any event, when the user, autonomous robot, camera system, and/or other component(s) or combinations thereof are in position to capture image data of the first asset, these users/robots/components may capture the image data for analysis by the systems described herein.

The method 600 may further include determining whether the first asset is depicted in the image data (block 610). In certain instances, the first asset may not be collocated with the associated tag, such that the image data of the tag at the estimated location may not always include the first asset. If the captured image data does not include the first asset (No branch of block 610), then the method 600 may further include generating and transmitting a first alert (e.g., an alert instruction). The first alert may be indicative of the first asset being stolen, as the tag is not at a display location of the first asset and the first asset is not collocated with (e.g., has been separated from) the tag.

However, if the systems described herein determine that the first asset is depicted in the captured image data (Yes branch of block 610), the method 600 may further include determining whether the first asset depicted in the captured image data is among a plurality of other assets associated with a second cluster (block 614). If the systems described herein determine that the first asset is depicted among a plurality of other assets associated with a second cluster (Yes branch of block 614), then the method 600 may further include generating and transmitting a second alert (e.g., an alert instruction) (block 616). The second alert may be indicative of the first asset being misplaced within, for example, a retail environment. Accordingly, the method 600 may further include transmitting instructions that indicate and/or cause a user or autonomous robot to relocate the first asset to the first cluster (block 618). For example, the second alert may include instructions that, when executed by an autonomous robot, cause the robot to retrieve the first asset and relocate the first asset from the estimated location to the first cluster.

If the systems described herein determine that the first asset is not depicted among a plurality of other assets associated with a second cluster (No branch of block 614), the method 600 may further include determining whether the first asset is the only/last asset depicted in the captured image data (block 620). If the systems described herein determine that the first asset is not the only/last asset depicted in the captured image data, the method 600 may terminate, as the first asset is collocated with the corresponding tag and is at a corresponding display location (e.g., the first cluster) with at least one other asset belonging to the first cluster. However, if the systems described herein determine that the first asset is the only/last asset depicted in the captured image data (Yes branch of block 620), the method 600 may further include generating and transmitting a third alert (e.g., alert instructions) (block 622). The third alert may generally be indicative of planogram management instructions or recommendations. For example, these planogram management instructions/recommendations may indicate whether to relocate the first asset from the first cluster to another cluster having assets from the same group of assets that includes the first asset, or to relocate assets from the another cluster to the first cluster.

Of course, it is to be appreciated that the actions of the method 600 may be performed in any suitable order and any suitable number of times.

### ADDITIONAL CONSIDERATIONS

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

What is claimed is:

1. A system comprising:
one or more processors; and
one or more memories communicatively coupled to the one or more processors, the one or more memories storing instructions thereon that, when executed by the one or more processors, cause the system to:
receive one or more signals from one or more tags, each tag of the one or more tags being clustered into one or more clusters, and each tag of the one or more tags being associated with an asset of one or more assets,
generate, based on the one or more signals, a location estimate for the one or more tags,
identify, based on the location estimates, a respective cluster of the one or more clusters that satisfies a cluster threshold,
determine whether a tag associated with the respective cluster (i) satisfies a first location threshold relative to the asset associated with the tag and (ii) satisfies a second location threshold relative to another cluster location,
determine, based on (i) and (ii), an alert instruction corresponding to the tag, and
transmit the alert instruction to a user device.

2. The system of claim 1, wherein the instructions, when executed by the one or more processors, further cause the system to:
group, based on an associated asset of the one or more assets, each tag of the one or more tags into one or more groups; and
wherein each signal of the one or more signals at least one of: (i) indicates a group of the one or more groups associated with the respective asset or (ii) causes the system to retrieve an indication of the group associated with the respective asset.

3. The system of claim 2, wherein each asset of the one or more assets includes an asset identifier that indicates (i) an asset type and (ii) an asset attribute, and the instructions, when executed by the one or more processors, further cause the system to group each tag of the one or more tags into the one or more groups by:
determining, for each asset of the one or more assets based on the asset type and the asset attribute, a similarity value between each pair of assets from the one or more assets; and
grouping, based on the similarity values, each tag of the one or more tags into the one or more groups.

4. The system of claim 2, wherein the instructions, when executed by the one or more processors, further cause the system to:
cluster, by a distance limit clustering algorithm based on the location estimates of tags within respective groups of the one or more groups, the tags within the respective groups into the one or more clusters; and
wherein the distance limit clustering algorithm compares respective distances of each tag in a respective group to one or more other tags in the respective group to a distance threshold when clustering within each group.

5. The system of claim 4, wherein the distance limit clustering algorithm comprises at least one of: (i) an Agglomerative Hierarchical Clustering algorithm or (ii) a Density-Based Spatial Clustering of Applications with Noise (DBSCAN) algorithm.

6. The system of claim 2, wherein the instructions, when executed by the one or more processors, further cause the system to identify that the respective cluster satisfies the cluster threshold by:
determining that the tag is the only tag included in the respective cluster; and
determining that a respective group corresponding to the respective cluster also corresponds to another cluster of the one or more clusters.

7. The system of claim 2, wherein the cluster location is a first cluster location, and the instructions, when executed by the one or more processors, further cause the system to determine the alert instruction by:
determining that the tag (i) satisfies the first location threshold and (ii) satisfies the second location threshold; and
wherein the alert instruction comprises an indication to either:
(i) relocate the asset associated with the tag from the first cluster location to a second cluster location associated with another cluster of the one or more clusters, the another cluster comprising respective assets of the one or more assets included in a same group of the one or more groups as the asset associated with the tag, or
(ii) relocate the respective assets from the second cluster location to the first cluster location.

8. The system of claim 1, wherein the instructions, when executed by the one or more processors, further cause the system to determine the alert instruction by:
determining that the tag (i) satisfies the first location threshold and (ii) fails to satisfy the second location threshold; and
wherein the alert instruction comprises an indication to relocate the asset associated with the tag to the cluster location.

9. The system of claim 1, wherein the instructions, when executed by the one or more processors, further cause the system to determine the alert instruction by:
determining that the tag (i) fails to satisfy the first location threshold and (ii) fails to satisfy the second location threshold; and
wherein the alert instruction comprises an indication of (i) a time when a respective signal from the tag indicated a different location of the tag from a prior signal from the tag and (ii) a path of the tag from a current location of the tag to the cluster location.

10. The system of claim 1, wherein the instructions, when executed by the one or more processors, further cause the system to determine the alert instruction by:
determining that the tag (i) fails to satisfy the first location threshold and (ii) satisfies the second location threshold;
generating the alert instruction to comprise a removal indication corresponding to the tag; and
wherein transmitting the alert instruction to the user device causes the user device to remove the tag from a tag database in accordance with the removal indication.

11. The system of claim 1, wherein the tag is a first tag, and the instructions, when executed by the one or more processors, further cause the system to:
generate a misplaced tag list that includes the first tag and a second tag of the one or more tags;
determine a respective location of the second tag based on the respective signal corresponding to the second tag;
determine whether (i) a prior signal corresponding to the second tag satisfies a time threshold and (ii) the respective location of the second tag satisfies a historical location threshold; and
responsive to determining, for the second tag, that the prior signal fails to satisfy the time threshold and the respective location fails to satisfy the historical location threshold, remove the second tag from the misplaced tag list.

12. The system of claim 1, wherein the instructions, when executed by the one or more processors, further cause the system to:
capture image data of a respective location corresponding to the respective cluster; and
analyze the captured image data to determine whether the tag (i) satisfies the first location threshold and (ii) satisfies the second location threshold.

13. The system of claim 1, wherein the one or more tags are radio-frequency identification (RFID) tags, and the system further comprises one or more RFID readers configured to:
receive the one or more signals from the one or more RFID tags; and
generate, based on the one or more signals, the location estimates for the one or more tags, wherein the location estimates comprise three-dimensional (3D) locations for the one or more RFID tags.

14. The system of claim 1, wherein the instructions, when executed by the one or more processors, further cause the system to determine whether the tag (i) satisfies the first location threshold and (ii) satisfies the second location threshold by:
generating a direction instruction indicating directions to the location estimate of the tag based on a current location of at least one of: (i) a user, (ii) a device of the user, or (iii) an autonomous mobile device connected to the system; and
transmitting the direction instruction to the user device, wherein the user device includes at least one of: (i) the device of the user or (ii) the autonomous mobile device; or
generating, based on the location estimate of the tag, a control instruction configured to orient an imaging system to capture image data of the tag; and
transmitting the control instruction to the imaging system to (i) orient the imaging system in accordance with the control instruction and (ii) capture the image data of the tag.

15. The system of claim 14, wherein the instructions, when executed by the one or more processors, further cause the system to:
receive location confirmation data corresponding to the current location of the tag from at least one of: (i) the user, (ii) the device of the user, (iii) the autonomous mobile device, or (iv) the imaging system; and
determine whether the tag (i) satisfies the first location threshold and (ii) satisfies the second location based on the location confirmation data.

16. A method comprising:
receiving one or more signals from one or more tags, each tag of the one or more tags being clustered into one or more clusters, and each tag of the one or more tags being associated with an asset of one or more assets;
generating, based on the one or more signals, a location estimate for the one or more tags;
identifying, based on the location estimates, a respective cluster of the one or more clusters that satisfies a cluster threshold;
determining whether a tag associated with the respective cluster (i) satisfies a first location threshold relative to the asset associated with the tag and (ii) satisfies a second location threshold relative to another cluster location;
determining, based on (i) and (ii), an alert instruction corresponding to the tag; and
transmitting the alert instruction to a user device.

17. The method of claim 16, further comprising:
grouping, based on an associated asset of the one or more assets, each tag of the one or more tags into one or more groups; and
wherein each signal of the one or more signals at least one of: (i) indicates a group of the one or more groups associated with the respective asset or (ii) causes retrieval of an indication of the group associated with the respective asset.

18. The method of claim 17, wherein each asset of the one or more assets includes an asset identifier that indicates (i) an asset type and (ii) an asset attribute, and grouping each tag of the one or more tags into the one or more groups further comprises:
determining, for each asset of the one or more assets based on the asset type and the asset attribute, a similarity value between each pair of assets from the one or more assets; and
grouping, based on the similarity values, each tag of the one or more tags into the one or more groups.

19. The method of claim 17, further comprising:
clustering, by a distance limit clustering algorithm based on the location estimates of tags within respective groups of the one or more groups, the tags within the respective groups into the one or more clusters; and
wherein the distance limit clustering algorithm compares respective distances of each tag in a respective group to one or more other tags in the respective group to a distance threshold when clustering within each group.

20. A tangible machine-readable medium comprising instructions that, when executed, cause a machine to at least:
receive one or more signals from one or more tags, each tag of the one or more tags being clustered into one or more clusters, and each tag of the one or more tags being associated with an asset of one or more assets;
generate, based on the one or more signals, a location estimate for the one or more tags;
identify, based on the location estimates, a respective cluster of the one or more clusters that satisfies a cluster threshold;
determine whether a tag associated with the respective cluster (i) satisfies a first location threshold relative to the asset associated with the tag and (ii) satisfies a second location threshold relative to another cluster location;
determine, based on (i) and (ii), an alert instruction corresponding to the tag; and
transmit the alert instruction to a user device.
